(19) United States
(12) Patent Application Publication
(10) Pub. No.: US 2012/0260051 A1
(43) Pub. Date: Oct. 11, 2012

(54) COMPUTER SYSTEM, MANAGEMENT SYSTEM AND DATA MANAGEMENT METHOD

(75) Inventors: Nobuhiro Maki, Yokohama (JP); Masayasu Asano, Yokohama (JP)

(73) Assignee: Hitachi, Ltd.

(21) Appl. No.: 13/128,161

(22) PCT Filed: Mar. 1, 2011
(86) PCT No.: PCT/JP11/54597

§ 371 Date: May 6, 2011

(51) Int. Cl. G06F 12/16

(52) U.S. Cl. 711/162; 711/E12.103

(57) ABSTRACT

A controller of a storage system migrates data managed in a virtual storage area of a virtual logical volume from an assigned real storage area to a real storage area of another storage medium with different characteristics according to predetermined conditions, and also executes copy processing for copying, to a second virtual logical volume, data in a copy target area being at least a part of a virtual storage area of a first virtual logical volume. When the second virtual logical volume is used, a management system controls the controller so as to migrate data of at least a part of the data that has been replicated in the second virtual logical volume by the copy processing, to a real storage area of the storage medium with more favorable characteristics.

### TECHNICAL FIELD

The present invention relates to a computer system including a storage system comprising a virtual logical volume, to a management system of such a storage system, and to a data management method.

### BACKGROUND ART

In recent years, the amount of data in corporations, universities and the like is increasing explosively, and storage systems for storing such data are also becoming large scale. Meanwhile, the investment cost that is allowed for storage systems does not increase in proportion to the speed of the increase of data. Thus, the challenges of a storage system are to realize methods of running the system inexpensively yet with high performance.

In light of the above, storage technology that has been attracting attention in recent years is storage virtualization. Storage virtualization is the technology of virtualizing the storage capacity, storage apparatus or the like. For example, Patent Literature 1 discloses technology of virtualizing the storage capacity of a storage. According to this technology, data that was written from a host computer for a virtual volume within the storage system can be selectively stored, according to requirements, in storage hierarchies of different response performance and reliability. In addition, disclosed is technology for a storage to migrate, to the appropriate storage hierarchy, fragments of data stored in a certain storage hierarchy based on data access characteristics and the like from a host computer. According to this technology, data that does not require performance can be disposed in an inexpensive storage hierarchy, and data requiring performance can be disposed in an expensive, high performance storage hierarchy.

Meanwhile, the backup recovery which has been conventionally implemented by the host computer by using its own CPU requires the storage of vast amounts of data in a storage system, and there was no choice but to consume the CPU load for a long period of time. Thus, in recent years, the method of realizing backup recovery by utilizing the copy function of a storage system is becoming mainstream. For example, with the technology disclosed in Patent Literature 2, data in a volume (primary volume) which is accessed by a host computer using a storage system is replicated, as the same data but as data of a different time frame, in a plurality of volumes (secondary volumes) based on the copy function of the storage system.

### CITATION LIST

### Patent Literature

[PTL 1] Japanese Unexamined Patent Application Publication No. 2007-066259
[PTL 2] Japanese Unexamined Patent Application Publication No. 2003-140981

### SUMMARY OF INVENTION

### Solution to Problem

Here, considered is a case of combining the storage virtualization technology of Patent Literature 1 and the copy technology of Patent Literature 2. Data in a secondary volume that was replicated by the copy function within the storage system is not used immediately after it has been replicated; for instance, it is used when data of the primary volume becomes corrupted. Thus, if data is migrated between storage hierarchies based on the trend of data access of the secondary volume, data will be disposed in a low performance storage hierarchy, and the expected performance cannot be obtained immediately after the use of the secondary volume. Moreover, in recent years, there are cases where a host computer, on which a separate application for performing analysis work is running, uses data in a secondary volume that was replicated by the copy function of the storage system in addition to a case of performing backup recovery. In the foregoing case, even if the secondary volume is used by the host computer immediately after data is replicated by the copy function, the data access trend of the secondary volume will differ from the host computer that used a primary volume, and the expected performance cannot be obtained immediately after the use of the secondary volume.

The present invention was devised in view of the foregoing problems. Thus, an object of this invention is to enable the use of a secondary volume with a suitable performance according to the intended use thereof.

### Means for Solving the Problems

The computer system according to one aspect of the present invention includes a storage system, and a management system of that storage system. The storage system includes a pool configured from real storage areas of a plurality of storage media with different characteristics, a plurality of virtual logical volumes configured from virtual storage areas each of which is assigned with a real storage area among the real storage areas configuring the pool, and a controller for controlling the assignment of the real storage areas to the virtual storage areas configuring the virtual logical volumes. The management system can manage and/or control operations in the storage system. The controller migrates data managed in the virtual storage area of the virtual logical volume from the assigned real storage area to a real storage area of another storage medium with different characteristics according to predetermined conditions, and executes copy processing for copying, to a second virtual logical volume (secondary volume), data in a copy target area being at least apart of a virtual storage area of a first virtual logical volume. When the second virtual logical volume is used, the management system controls the controller so as to migrate data of at least a part of the data that has been replicated in the second virtual logical volume by the copy processing, to a real storage area of the storage medium with more favorable characteristics.

### BRIEF DESCRIPTION OF THE DRAWINGS

FIG. 1 is a configuration diagram of the computer system in the first embodiment.

FIG. 2 is a configuration diagram of the management computer in the first embodiment.

FIG. 3 is a configuration diagram of the host computer in the first embodiment.

FIG. 4 is a configuration diagram of the storage system in the first embodiment.

FIG. 5 is a diagram showing the outline of operation of the storage system when the storage system 300 in the first embodiment provides two logical volumes of 20 GB and 10 GB to the host computer 200.

FIG. 6 is a diagram showing the outline of operation of the storage hierarchy control when the storage system 300 in the first embodiment implements the copy function.

FIG. 7 is a configuration diagram of the copy information table 113 stored in the management computer 100 in the first embodiment.

FIG. 8 is a configuration diagram of the protected data management table 115 stored in the management computer 100 in the first embodiment.

FIG. 9 is a configuration diagram of the host computer management table 111 stored in the management computer 100 in the first embodiment.

FIG. 10 is a configuration diagram of the catalog management table 116 stored in the management computer 100 in the first embodiment.

FIG. 11 is a configuration diagram of the storage information table 114 stored in the management computer 100 in the first embodiment.

FIG. 12 is a configuration diagram of the hierarchy table 117 stored in the management computer 100 in the first embodiment.

FIG. 13 is a configuration diagram of the copy pair management information 1210 stored in the storage system 300 in the first embodiment.

FIG. 14 is a configuration diagram of the volume management information 1250 stored in the storage system 300 in the first embodiment.

FIG. 15 is a configuration diagram of the virtual logical volume management information 1270 stored in the storage system 300 in the first embodiment.

FIG. 16 is a configuration diagram of the storage hierarchy pool management information 1290 stored in the storage system 300 in the first embodiment.

FIG. 17 is a configuration diagram of the storage basic information 1260 stored in the storage system 300 in the first embodiment.

FIG. 18 is a diagram explaining the configuration of the request 7300.

FIG. 19 is an example of the flowchart of the management operation in the environment creation stage performed by the management computer 100 in the first embodiment.

FIG. 20 is an example of the management screen for deciding the data of the copy target application program provided by the management computer 100 in the first embodiment.

FIG. 21 is an example of the management screen for defining the protection requirements provided by the management computer 100 in the first embodiment.

FIG. 22 is an example of the flowchart of the data access processing in the storage system 300 in the first embodiment.

FIG. 23 is an example of the flowchart of the page assignment processing for assigning a page from a pool in the storage system 300 in the first embodiment.

FIG. 24 is an example of the flowchart of the local copy start processing based on a clone to be executed by the storage system 300 in the first embodiment.

FIG. 25 is an example of the flowchart of the operation during temporary suspension of the local copy based on a clone in the first embodiment.

FIG. 26 is an example of the flowchart of the operation of temporary synchronization of the local copy based on a clone in the first embodiment.

FIG. 27 is an example of the flowchart of the operation of starting the local copy based on a snapshot in the first embodiment.

FIG. 28 is an example of the flowchart of the operation during temporary suspension of the local copy based on a snapshot in the first embodiment.

FIG. 29 is an example of the flowchart of the operation of temporary synchronization of the local copy based on a snapshot in the first embodiment.

FIG. 30 is an example of the flowchart of the storage hierarchy control processing in the first embodiment.

FIG. 31 is an example of the flowchart of the management operation in the data replication stage performed by the management computer 100 in the first embodiment.

FIG. 32 is an example of the flowchart of the management operation in the data use stage performed by the management computer 100 in the first embodiment.

FIG. 33 is an example of the flowchart of the operation of the quick restoration which is common to the snapshot and clone executed by the storage system 300 in the first embodiment.

FIG. 34 is an example of the flowchart of the operation of restoring the snapshot and clone executed by the storage system 300 in the first embodiment.

FIG. 35 is a diagram explaining the outline of virtual machine deployment performed by the management computer 100 in the second embodiment.

FIG. 36 is an example of the flowchart of the management operation for hotspot load distribution of the virtual machine deploy performed by the management computer 100 in the second embodiment.

### DESCRIPTION OF EMBODIMENTS

Certain embodiments of the present invention are now explained with reference to the appended drawings.

Note that, in the ensuing explanation, various types of information are explained using the expression of “xxx table,” but the various types of information may also be expressed with a data structure other than a table. In order to show that the various types of information are not dependent on the data structure, “xxx table” can also be referred to as “xxx information”.

Moreover, in the ensuing explanation, processing is sometimes explained by using the term “program” as the subject. However, since a program performs predetermined processing while suitably using a storage resource (for example, a memory) and/or a communication interface device (for example, a communication port) as a result of being executed by a processor (for example, a CPU (Central Processing Unit)) included in a controller, the term “processor” can also be used as the subject to processing. Processing that is explained using the term “program” as the subject can be processing that is performed by a processor, or a management system (for example, a display computer (for example, a client) or a management computer (for example, a server)) including such a processor. Moreover, the controller may itself be the processor, or include a hardware circuit which partially or entirely performs the processing to be performed by the controller. A program may be installed into the respective controllers from a program source. A program source may be, for example, a program distribution server or a storage media.

Note that a management computer includes an I/O device. Examples of an I/O device include a display, a keyboard, and a pointer device, but other devices may also be used. Moreover, in substitute for an I/O device, a serial interface or Ethernet interface (Ethernet is a registered trademark) may be used as the I/O device, and a display computer including a display or a keyboard or a pointer device on such interface can be coupled thereto for sending information to be displayed to the display computer or receiving information to be input from the display computer in order to display such information on the display computer, or the input and display can be substituted using an input device by receiving inputs.

The aggregate of one or more computers which manages the computer system and which manages and controls the storage system is hereinafter referred to as the “management system”. When the management computer is to display information to be displayed, the management computer is the management system. Moreover, the combination of a management computer and a display computer is also a management system. In addition, a plurality of computers may be used for realizing the same level of processing as the management computer for achieving the faster speed and higher reliability of the management processing. In the foregoing case, such plurality of computers (including a display computer if a display computer is to display information) are the management system.

Moreover, the term “time” is used in the ensuing explanation, and time may indicate information such as year, month or day, and may also indicate the hour, minute or second (including seconds after the decimal point) as a matter of course.

### Example 1

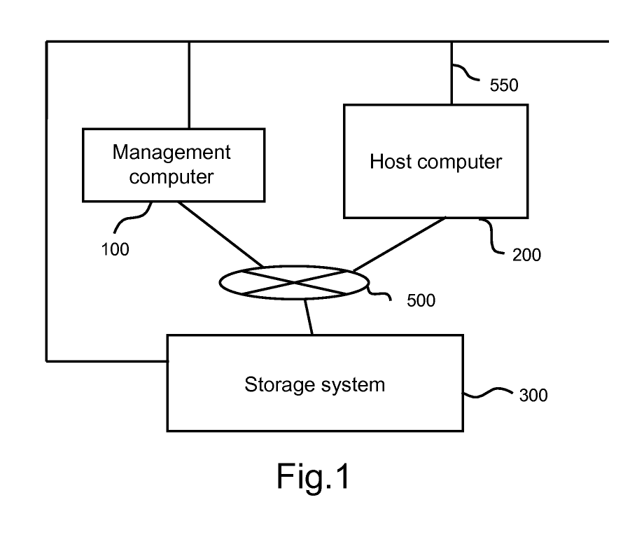

FIG. 1 is a configuration diagram of the computer system in the first embodiment of the present invention.

The computer system includes a management computer 100, a host computer 200, and a storage system 300. In the computer system, the management computer 100 and the host computer 200 may respectively provided as one computer or a plurality of computers. Moreover, in the computer system, the storage system 300 may be provided as one system or a plurality of systems.

The management computer 100, the host computer 200 and the storage system 300 are mutually coupled via a communication network (for example, a SAN (Storage Area Network)) 500. Moreover, the management computer 100 is coupled to the host computer 200 and the storage system 300 via a communication network (for example, a LAN (Local Area Network)) 550.

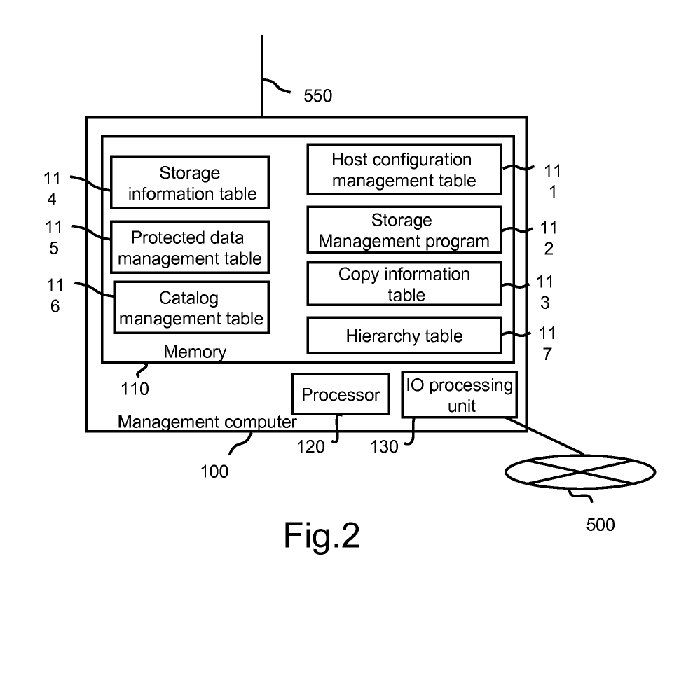

FIG. 2 is a configuration diagram of the management computer in the first embodiment.

The management computer 100 is a computer including a memory 110, a processor 120 and an IO processing unit 130. The memory 110, the processor 120 and the IO processing unit 130 are mutually coupled via an internal network (not shown).

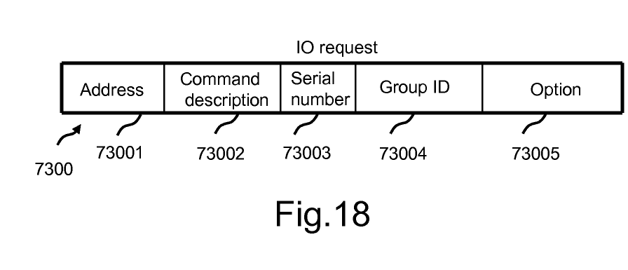

The processor 120 performs various types of processing by executing programs stored in the memory 110. For example, the processor 120 controls the copy to be executed by the storage system 300 by sending an IO request to the storage system 300. An IO request includes a write request, a read request, a copy control request and so on. The IO request will be described in detail later with reference to FIG. 18.

The memory 110 stores programs to be executed by the processor 120 and information and the like which are required by the processor 120. Specifically, the memory 110 stores a host configuration management table 111, a storage management program 112, a copy information table 113, a storage information table 114, a protected data management table 115, a catalog management table 116, and a hierarchy table 117. The memory 110 may additionally store an OS (Operating System) and an application program (AP).

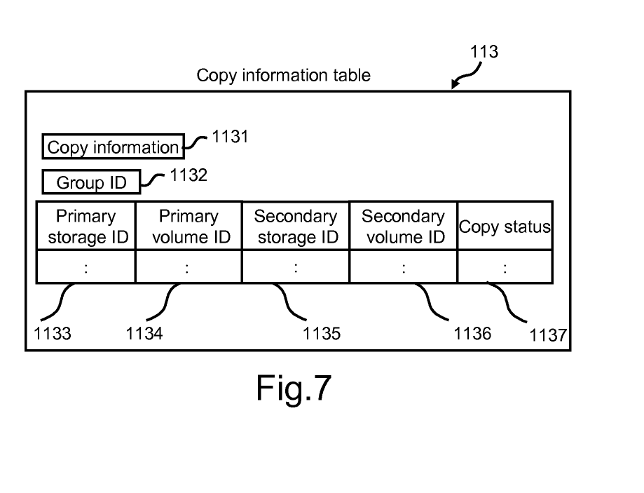

The host configuration management table 111 is information for managing a host computer using data to become the copy target described later. The storage management program 112 is a program for managing the storage system 300. The copy information table 113 is information for managing the configuration and status of the local copy and remote copy as the data copy functions of the storage system 300. Thus, the memory 110 stores the copy information table 113 in the same number as the copies managed by the management computer 100; that is, the same number as the sum of local copies and remote copies. Note that the copy information table 113 will be described in detail later with reference to FIG. 7. The local copy and remote copy will also be described later.

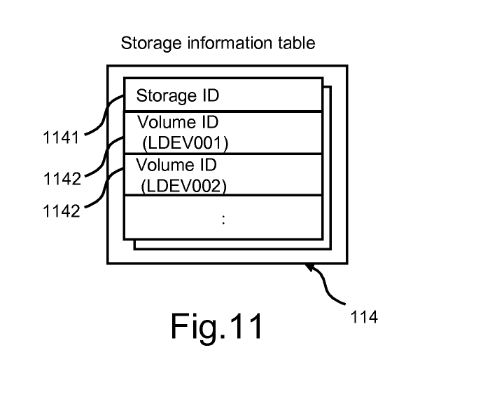

The storage information table 114 is information concerning the storage system 300 which is managed by the management computer 100. Note that the storage information table 114 will be described in detail later with reference to FIG. 11.

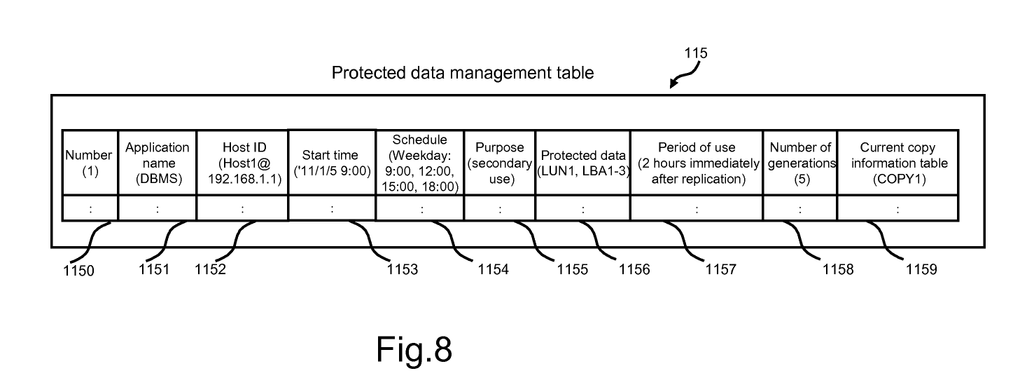

The protected data management table 115 is information for retaining information and the like related to the protected data (copy target data) described later. Note that the protected data management table 115 exists in the same number as the number of data that was registered by the user in the management computer 100 as data to be protected. The protected data management table 115 will be described in detail later with reference to FIG. 8.

The catalog management table 116 is information for retaining information and the like related to the protection time of the protected data described later. Note that the catalog management table 116 will be described in detail later with reference to FIG. 10.

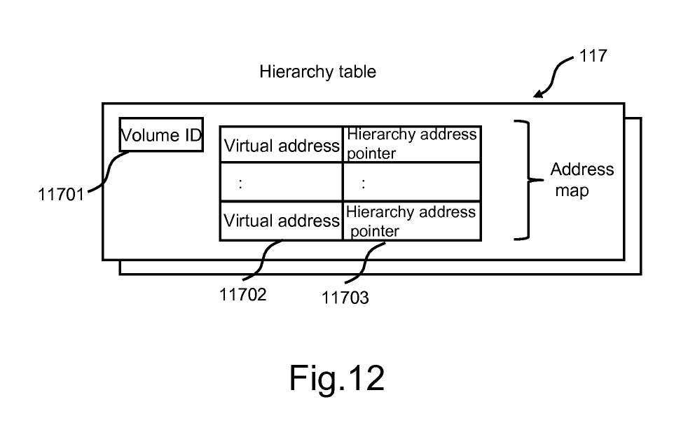

The hierarchy table 117 is a table for retaining in which real volume the designated logical volume was disposed based on the storage hierarchy control described later. The hierarchy table 117 is characteristic information capable of identifying the characteristics of a storage medium including a real storage area assigned to a primary volume. Note that the hierarchy table 117 will be described in detail later with reference to FIG. 12.

The IO processing unit 130 is an interface that is coupled to the host computer 200 and the storage system 300 via the communication network 500.

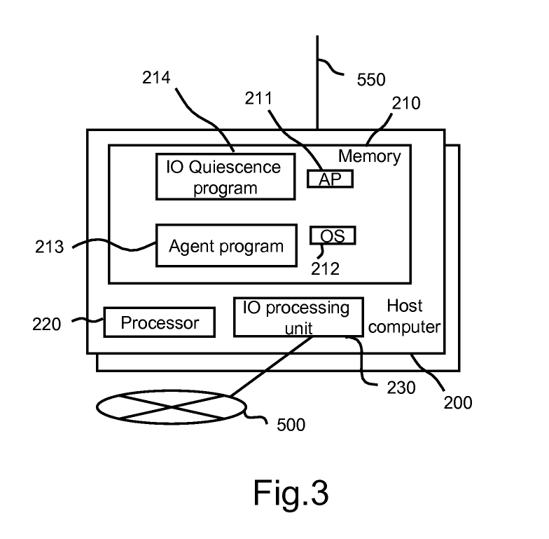

FIG. 3 is a configuration diagram of the host computer in the first embodiment.

The host computer 200 is a computer including a memory 210, a processor 220 and an IO processing unit 230. The memory 210, the processor 220 and the IO processing unit 230 are mutually coupled via an internal network (not shown).

The processor 220 performs various types of processing by executing the programs stored in the memory 210. For example, the processor 220 accesses data of a logical volume (real logical volume, virtual logical volume) of the storage system 300 by sending an IO request to the storage system 300.

The memory 210 stores programs to be executed by the processor 220 and information and the like which are required by the processor 220. Specifically, the memory 210 stores an application program (AP) 211, an OS 212, an agent program 213 and an IO quiescence program 214.

The AP 211 executes various types of processing. For example, the AP 211 provides a database function or an email server function. The OS 212 controls the overall processing of the host computer 200. The agent program 213 receives commands from the management computer 100. The IO quiescence program 214 coordinates with the OS 212 and controls the IO request.

The IO processing unit 230 is an interface for communicating with the management computer 100 and the storage system 300 via the communication network 500. Specifically, for example, the IO processing unit 230 sends an IO request to the storage system 300.

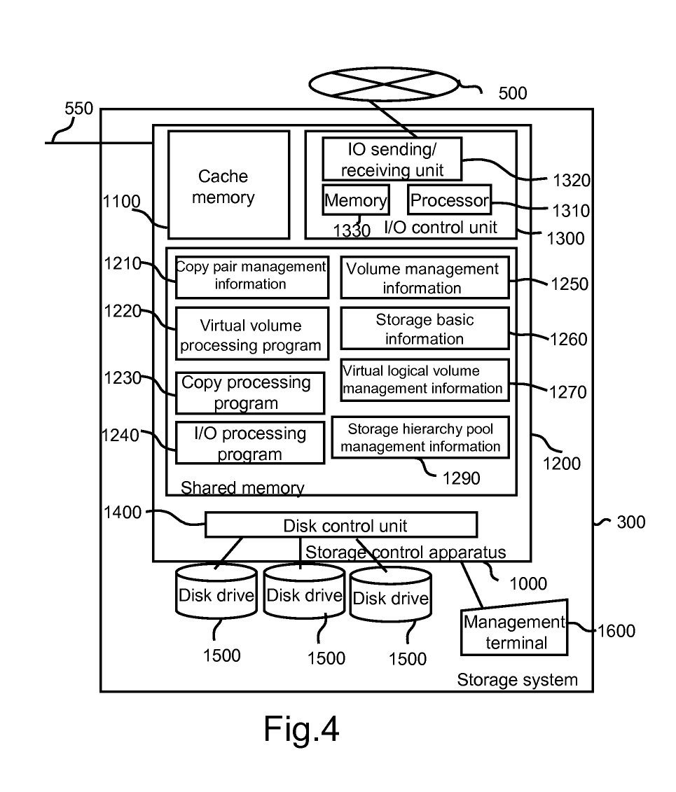

FIG. 4 is a configuration diagram of the storage system in the first embodiment.

The storage system 300 comprises a storage control apparatus 1000, a plurality of disk drives 1500, and a management terminal 1600. In FIG. 4, the management terminal 1600 is directly coupled to the storage control apparatus 1000 within the storage system 300, but it may also be coupled to the storage system 300 via at least one of the communication networks 500, 550. The storage control apparatus 1000 and the plurality of disk drives 1500 are mutually coupled via an internal network.

The disk drive 1500 is a disk-type storage media drive, and stores data for which a writing request was sent by the host computer 200. The storage system 300 may also internally comprise a storage device (for example, flash memory drive) including other types of storage media in addition to the disk drive 1500 or in substitute for the disk drive 1500.

The storage control apparatus 1000 controls the operation of the storage system 300. For example, the storage control apparatus 1000 controls the writing of data into the disk drive 1500 and the reading of data from the disk drive 1500. Moreover, the storage control apparatus 1000 provides one or more logical volumes to the management computer 100 and the host computer 200. The one or more logical volumes is configured from one of either a real volume or a virtual volume. A real volume is one or more logical storage areas formed based on the storage space of one or more disk drives 1500. A virtual volume is a virtual volume which uses a part of the area of the real volume. The real volume and the virtual volume will be described later in detail.

The storage control apparatus 1000 comprises a cache memory 1100, a shared memory 1200, an I/O control unit 1300 and a disk control unit 1400. The cache memory 1100, the shared memory 1200, the I/O control unit 1300 and the disk control unit 1400 are mutually coupled via an internal network (not shown).

The cache memory 1100 temporarily stores the data that is written into the disk drive 1500 and the data that is read from the disk drive 1500. The disk control unit 1400 controls the writing of data into the disk drive 1500 and the reading of data from the disk drive 1500. Moreover, the disk control unit 1400 generates a real volume based on the storage space of one or more disk drives 1500.

The I/O control unit 1300 comprises a processor 1310, an IO send/receive unit 1320 and a memory 1330. The processor 1310, the IO send/receive unit 1320 and the memory 1330 are mutually coupled via an internal network (not shown). The IO send/receive unit 1320 is an interface for communicating with another apparatus (for example, at least one among the management computer 100, the host computer 200 and another storage system 300) via the communication network 500. Specifically, for example, the IO send/receive unit 1320 receives an IO request from the management computer 100 or the host computer 200. Moreover, the IO send/receive unit 1320 sends the data that was read from the disk drive 1500 to the management computer 100 or the host computer 200. The processor 1310 performs various types of processing by executing the programs stored in the memory 1330 or the shared memory 1200. Specifically, for example, the processor 1310 processes the IO request that was received by the IO send/receive unit 1320. The memory 1330 stores programs to be executed by the processor 1310 and information and the like which are required by the processor 1310.

The shared memory 1200 stores programs to be executed by the processor 1310 and information and the like which are required by the processor 1310. In addition, the shared memory 1200 stores programs to be executed by the disk control unit 1400 and information and the like which are required by the disk control unit 1400. Specifically, for example, the shared memory 1200 stores copy pair management information 1210, a virtual volume processing program 1220, a copy processing program 1230, an I/O processing program 1240, volume management information 1250, virtual logical volume management information 1270 and storage hierarchy pool management information 1290.

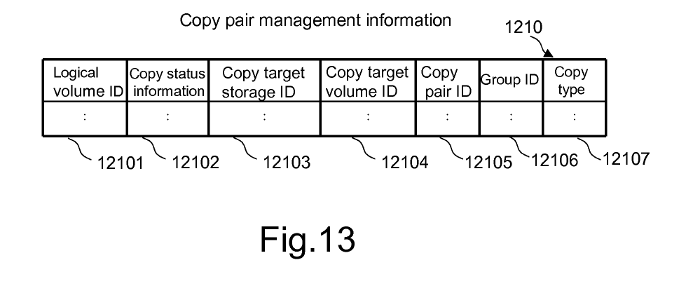

The copy pair management information 1210 is information for managing a copy pair including the logical volume provided by the storage system 300. A copy pair is a copy configuration which is configured from two logical volumes to be subject to local copy or remote copy. Note that the copy pair management information 1210 will be described in detail later with reference to FIG. 13.

The virtual volume processing program 1220 implements processing related to the virtual volume. The copy processing program 1230 performs local copy. The I/O processing program 1240 processes the IO requests that are received by the IO send/receive unit 1320.

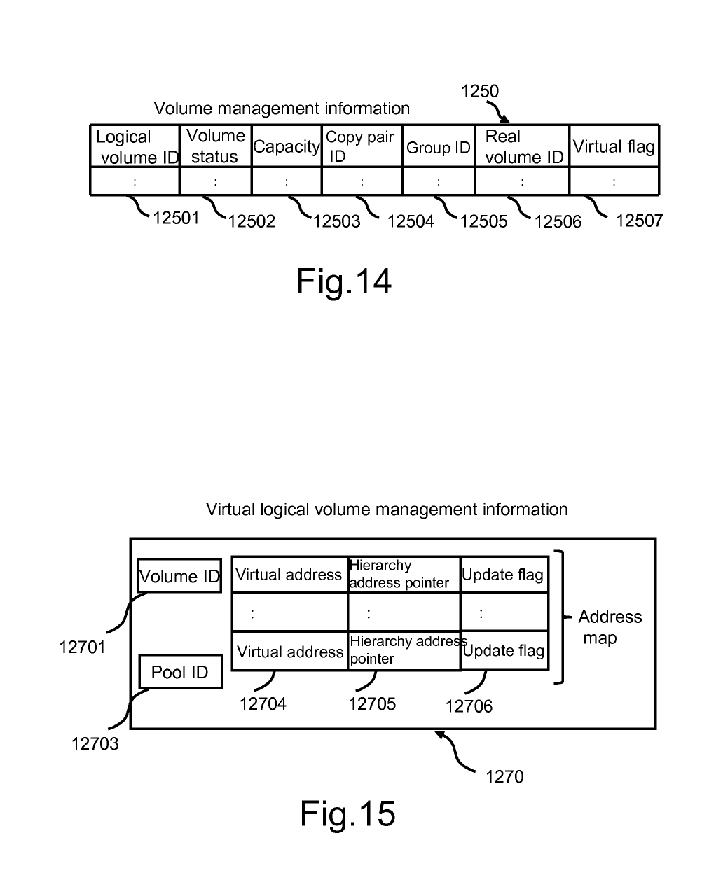

The volume management information 1250 is information for managing the logical volumes that are provided by the storage system 300. Note that the volume management information 1250 will be described in detail later with reference to FIG. 14.

The virtual logical volume management information 1270 is corresponding information of the virtual storage area of the virtual logical volume and the assigned area (real storage area) of the real volume. Note that the virtual logical volume management information 1270 will be described in detail later with reference to FIG. 15.

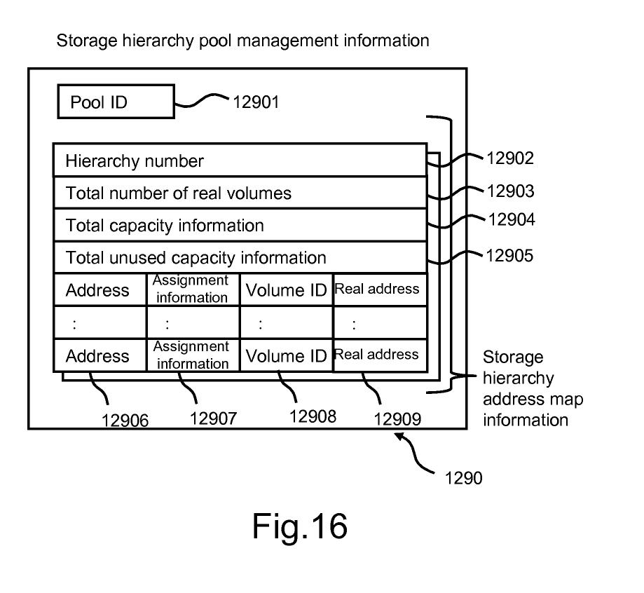

The storage hierarchy pool management information 1290 is information for managing the logical volumes that can be assigned to the virtual logical volume. Note that the storage hierarchy pool management information 1290 will be described in detail later with reference to FIG. 16.

The management terminal 1600 is a computer comprising a processor, a memory and an interface (not shown). The management terminal 1600 sends the information which was input by the system operator (user) to the storage control apparatus 1000 of the storage system 300.

The outline of processing performed in the first embodiment of the present invention is now explained.

The relationship of logical volumes, real logical volumes, and virtual logical volumes as the premise of this embodiment is foremost explained.

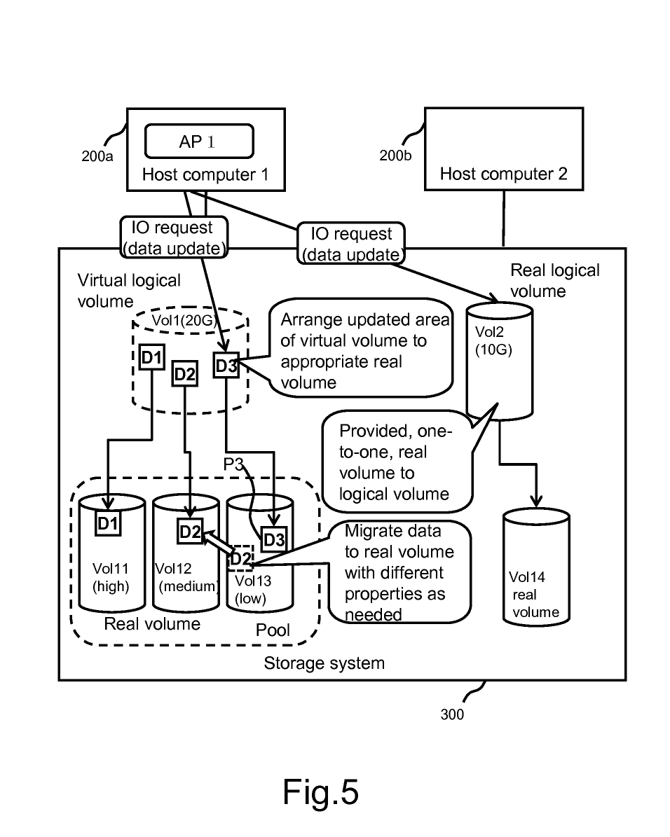

FIG. 5 shows the operation of the storage system when the storage system 300 provides two logical volumes of 20 GB and 10 GB to the host computer 200. In FIG. 5, host computers 200a, 200b exist, but there is no difference between the two host computers, and the suffix of “a” and “b” will be added after the number only in cases where it is necessary to differentiate the host computers in the explanation. The logical volume is configured from one of either a real volume or a virtual volume. In order to differentiate the respective logical volumes in this embodiment, a logical volume configured from a real volume is referred to as areal logical volume, and a logical volume configured from a virtual volume is referred to as a virtual logical volume.

In FIG. 5, Vol 2 corresponds to a real logical volume, and Vol 1 corresponds to a virtual logical volume. The real volume is one or more logical storage areas formed based on the storage area of one or more disk drives 1500. The storage system 300 in this embodiment includes a real volume comprising a plurality of different characteristics. Characteristics are, for example, differences in the type of disk drive such as differences in the rotational speed of the disk or the interface such as FC, SAS, and SATA, and differences in the method (RAID level or the like) of forming the storage area from the disk drives, and, based on the differences in these characteristic, the time required for reading and writing data and the possibility of recovery from a hardware failure will differ. Here, RAID is the abbreviation of Redundant Array of Independent (or Inexpensive) Disks. Moreover, a RAID level is the classification of the reliability and performance of the real volumes. Specifically, the RAID level is classified based on differences in the means of, for example, distributing, duplicating and retaining fragments of data in a plurality of disk drives 1500 by dividing and replicating the data written from the host computer 200, or creating parity data and the like required for restoring the data and simultaneously retaining this together with the data of the host computer 200.

The virtual logical volume is a virtual volume that uses the fragments of the storage area in a real volume. In FIG. 5, as an example thereof, a data element D3 is stored in one area of the virtual logical volume (Vol 1) based on a data IO request from the host computer 200, but in reality, the data element D3 is stored in a fragment (P3) of the storage area of the real volume that was assigned to that area. The “fragment of a storage area” that was assigned to a real volume for the reading and writing of data from and to the virtual logical volume is hereinafter referred to as a “page” and data stored in a page (in other words, data stored in a virtual area as the assignment destination of the page) is hereinafter referred to as a “data element”. In FIG. 5, the page P3 is provided from the real volume (Vol 13). Moreover, under normal circumstances, in order to differentiate the real volume for use as a real logical volume and the real volume for use as a virtual logical volume to be accessed from the host computer 200, in the storage system 300, the real volume for use as a virtual logical volume is registered in a special group (hereinafter referred to as the “pool”) and thereby managed. One or more real volumes with different characteristics are registered together with characteristic information in a pool.

Moreover, with the storage system 300, pages are migrated in the virtual logical volume between real volumes with difference characteristics within the pool based on the characteristic information of the real volumes. In this embodiment, this is referred to as storage hierarchy control. An operational example of the storage hierarchy control is explained with reference to FIG. 5. Here, let it be assumed that, with the storage system 300, the difference in the response time of the reading and writing of data by the host computer 200 is being managed as the characteristic information (for example, high performance or medium performance). Here, if it is determined that the data access frequency from the host computer 200 to the page D2 has increased in comparison to the past, the storage system 300 migrates the page D2 from a real volume of low performance to a real volume of medium performance. As a result of implementing the foregoing page migration, the storage system 300 can provide a logical volume of appropriate performance according to the frequency that the host computer 200 accesses the data.

As described above, with the storage hierarchy control, pages are migrated between real volumes with difference characteristics within the pool. Note that, in this embodiment, the differences in characteristics of the real volumes to become the key in the page migration with the storage hierarchy control is referred to as the difference in “hierarchy”.

The storage hierarchy control in a case where the copy function is implemented with the target storage system 300 in this embodiment is now explained with reference to the drawings.

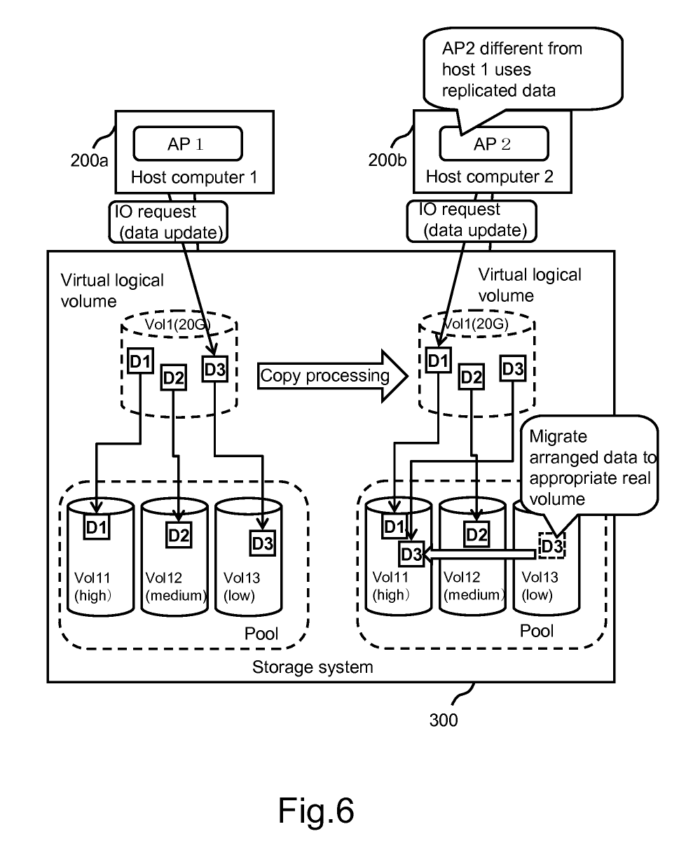

FIG. 6 is a diagram showing the outline of operation of the storage hierarchy control when the storage system 300 in the first embodiment implements the copy function.

Generally speaking, data that is replicated by the copy function is used for a variety of usages. As such usages, there are, for example, backup recovery, secondary use and so on. Here, backup recovery refers to the replication of the data generated by the host computer 200 at the designated time in a logical volume used by the host computer 200, as well as in a separate logical volume based on the copy function. It is thereby possible to prepare for an unexpected data failure (data corruption). Specifically, even in cases where data becomes unusable due to the malfunction of an application program running on the host computer 200 or an erroneous operation that was performed manually, the data access by the host computer 200 can be resumed by substituting the broken data with the data that was protected at a certain point in time based on the copy function of the storage system 300.

Meanwhile, secondary use is the use of the replication (protected data) of the data generated by the host computer 200a from the host computer 200b running on an application program (AP 2) that is different from the application program (AP 1) of the host computer 200a. This is used in cases where the processing data of the host computer 200a is to be analyzed for utilization in a separate use. With secondary use, since the AP 1 and the AP 2 are different, it is unique in that the tendency of accessing data by the host computer 200a and the host computer 200b will differ.

Here, considered is a case of using the copy function for the purpose of secondary use in the storage system 300 comprising the storage hierarchy control. As described above, in the case of secondary use, generally speaking, data access by the host computers 200a and 200b is performed with different tendency. Thus, there are cases where it is desirable for the storage system 300 to arrange the pages in the real volumes with different hierarchies between the virtual logical volumes of the copy source and copy destination based on the storage hierarchy control. Meanwhile, in the case of backup recovery, since the same host computer 200 accesses the virtual logical volumes of the copy source and copy destination, it is desirable for the storage system 300 to arrange the pages in the real volumes of a common hierarchy in the virtual logical volumes of the copy source and copy destination based on the storage hierarchy control.

Thus, in this embodiment, when using the copy function with the storage system 300 comprising the storage hierarchy control, storage hierarchy control according to the usage of the copy function is implemented. The operation thereof is now explained in detail. Note that the logical volume as the premise in this embodiment is a virtual logical volume. Unless it is necessary to differentiate the real logical volume and the virtual logical volume in this embodiment, a logical volume refers to a virtual logical volume.

FIG. 7 is a configuration diagram of the copy information table 113 stored in the management computer 100 in the first embodiment.

The copy information table 113 includes copy information 1131, a group ID 1132 and copy configuration information (1133 to 1137). The copy information table 113 exists in the management computer 100 in the same number as the number of copy processing to be implemented.

The copy information 1131 includes a copy type and copy option information. The copy type shows whether the copy managed by the copy information table 113 is a local copy or a remote copy. A local copy is the copy that is performed within the same storage system 300, and, in the foregoing case, the copy source logical volume (primary volume: PVOL) and the copy destination logical volume (secondary volume: SVOL) exist in the same storage system 300. A remote copy is the copy that is performed between different storage systems 300, and, in the foregoing case, the copy source logical volume and the copy destination logical volume exist in separate storage systems 300. The copy option information is information representing the options provided for each copy type. For example, the option information shows whether writing into the copy destination logical volume is possible during the temporary suspension of local copy. The temporary suspension of local copy refers to the temporary suspension of local copy based on a command from the management computer 100.

The group ID 1132 is a unique identifier concerning the group including a plurality of copy pairs (pair of the copy source logical volume and the copy destination logical volume). As a result of using a group, the management computer 100 can collectively control the copy pairs contained in that group.

The copy configuration information includes a primary storage ID 1133, a primary volume ID 1134, a secondary storage ID 1135 and a secondary volume ID 1136, and copy status information 1137.

The primary storage ID 1133 is a unique identifier of the storage system (primary storage system) 300 to provide the logical volume (primary volume) as the copy source. The primary volume ID 1134 is a unique identifier (ID) of the logical volume (primary volume) as the copy source.

The secondary storage ID 1135 is a unique identifier of the storage system (secondary storage system) 300 to provide the logical volume (secondary volume) as the copy destination. Note that, in the case of local copy, this becomes the same ID as the primary storage system. The secondary volume 1136 is a unique identifier of the logical volume (secondary volume) as the copy destination.

The copy status information 1137 shows the current status of the copy processing that is managed by the copy information table 113. Specifically, for example, the copy status information 1137 shows whether the status of copy processing managed by the copy information table 113 is no copy, copying, temporary suspension, pair status, or abnormal status.

FIG. 8 is a configuration diagram of the protected data management table 115 stored in the management computer 100 in the first embodiment.

The protected data management table 115 includes a number 1150, an application name 1151, a host ID 1152, a start time 1153, a schedule 1154, a purpose 1155, protected data 1156, period of use 1157, number of generations 1158, and a current copy information table 1159.

The number 1150 is a number for identifying the plurality of information of protected data stored in the protected data management table 115. The application name 1151 is an application (application program) name in the host computer 200 using the data to be subject to copy processing. The host ID 1152 is an identifier for uniquely identifying the host computer 200 on which the corresponding application is running. The start time 1153 is the time of starting the copy processing. The schedule 1154 stores the trigger for implementing the copy processing to be performed for data protection. For example, the schedule 1154 stores the copy processing start time such as a certain time (9:00, 12:00, 16:00 or the like) of weekdays (Monday through Friday). The purpose 1155 stores the purpose of copy processing; for example, information such as backup recovery, secondary use or the like.

The protected data 1156 is information (copy target area) concerning the location of the data to be subject to copy processing. As the location information, for example, stored are an ID (WWN (World Wide Name)+LUN (Logical Unit Number) or the like) to be assigned by the host computer 200 to the volume and the location (LBA (Logical Block Address) 1 to LBA 3 or the like) of the corresponding file in the volume. The period of use 1157 shows how long the data that was replicated by the corresponding copy processing will be used. For example, information such as 2 hours immediately after the completion of copy is stored. The number of generations 1158 shows the number of copy configurations (number of generations) with different secondary volumes with a common primary volume in the copy configuration. The current copy information table 1159 shows the copy information table 113 that is currently being used in the copy processing.

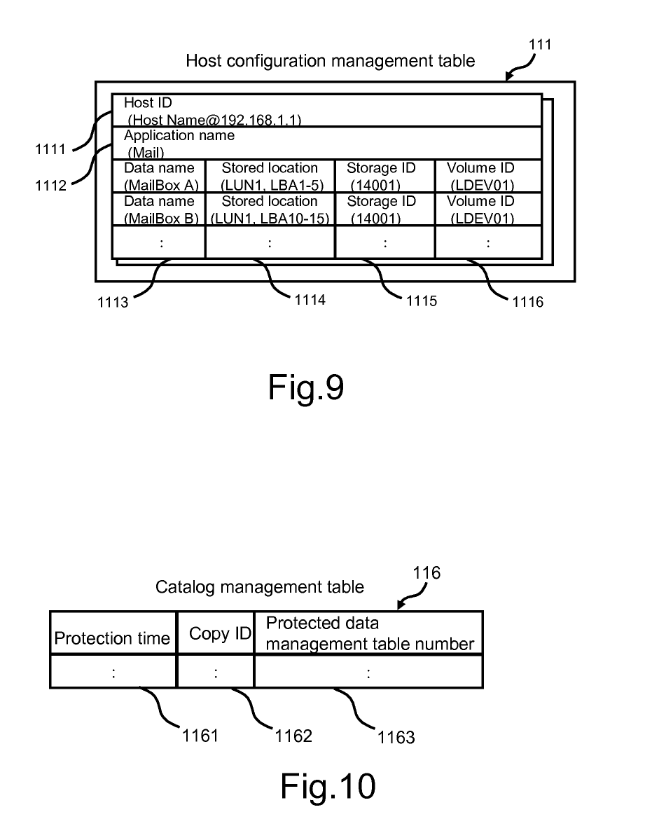

FIG. 9 is a configuration diagram of the host computer management table 111 stored in the management computer 100 in the first embodiment.

The host computer table 111 includes a host ID 1111, an application name 1112, a data name 1113, a storage location 1114, a storage ID 1115, and a volume ID 1116.

The host ID 1111 is a unique identifier of the host computer 200. For example, the host ID 1111 is combination of the Host Name and IP address of TCP/IP. The application name 1112 indicates the name of the application that is mainly running on the host computer 200. For example, information such as DBMS is stored.

The data name 1113 indicates the name of the data for the application described in the application name 1112. For example, as the data name, stored is the name of the data (Table 1) used in the application, or simply the file name. The storage location 1114 indicates the location information of the storage storing the data indicated by the data name. For example, information such as WWN 1, LUN 1 to LUN 5, or the like is stored. The storage ID 1115 is a unique identifier of the storage system 300 that is managed by the management computer 100. The volume ID 1116 is a unique identifier of the logical volume that was given by the storage system 300 identified by the storage ID 1115.

FIG. 10 is a configuration diagram of the catalog management table 116 stored in the management computer 100 in the first embodiment.

The catalog management table 116 includes a protection time 1161, a copy ID 1162, and a protected data management table number 1163.

The protection time 1161 indicates the time that the copy processing was complete. The copy ID 1162 is a unique identifier of the copy information table 113. The protected data management table number 1163 is a number for uniquely identifying the protected data management table 115.

FIG. 11 is a configuration diagram of the storage information table 114 stored in the management computer 100 in the first embodiment.

The storage information table 114 includes a storage ID 1141, and a volume ID 1142. The storage ID 1141 is a unique identifier of the storage system 300 that is managed by the management computer 100. The volume ID 1142 is a unique identifier of the logical volume that was given by the storage system 300 identified by the storage ID 1141.

FIG. 12 is a configuration diagram of the hierarchy table 117 stored in the management computer 100 in the first embodiment.

The hierarchy table 117 includes a volume ID 11701 and address maps (11702, 11703). The volume ID 11701 is an identifier of the real volume that is uniquely shown by the storage system 300. The address map is configured from a virtual address 11702, and a hierarchy address pointer 11703. The virtual address 11702 is an extent address indicating the virtual area of the virtual volume. The hierarchy address pointer 11703 is a pointer indicating one area of the storage hierarchy address map of a specific hierarchy of the storage hierarchy pool management information 1290. Specifically, the hierarchy number, and one address of the storage hierarchy address map that is provided for each hierarchy number are stored. Note that, when a page is not assigned to a virtual area, the hierarchy address pointer 12703 corresponding to the virtual address 12702 of that virtual area becomes information showing “unused”.

FIG. 13 is a configuration diagram of the copy pair management information 1210 stored in the storage system 300 in the first embodiment.

The copy pair management information 1210 includes a logical volume ID 12101, copy status information 12102, a copy target storage ID 12103, a copy target volume ID 12104, a copy pair ID 12105, a group ID 12106 and a copy type 12107.

The logical volume ID 12101 is a unique identifier of the logical volume to become the copy source or copy destination that is provided by the storage system 300 storing the copy pair management information 1210. The copy status information 12102 shows the current status of the copy processing performed to the logical volume which is identified by the logical volume ID 12101. Specifically, for example, the copy status information 12102 shows whether the logical volume identified by the logical volume ID 12101 as one among primary volume, secondary volume, copying, temporary suspension, or abnormal.

The copy target volume ID 12104 is a unique identifier of the logical volume to be a copy pair with the logical volume which is identified by the logical volume ID 12101. In other words, the copy target volume ID 12104 is a unique identifier of the logical volume to be the copy destination or copy source of the data stored in the logical volume which is identified by the logical volume ID 12101. The copy target storage ID 12103 is a unique identifier of the storage system 300 providing the logical volume to be a copy pair with the logical volume which was identified by the logical volume ID 12101. In other words, the copy target storage ID 12103 is a unique identifier of the storage system 300 providing the logical volume which is identified by the copy target volume ID 12104.

The copy pair ID 12105 is a unique identifier of the copy pair including the logical volume which is identified by the logical volume ID 12101 and the logical volume which is identified by the copy target volume ID 12104. The group ID 12106 is a unique identifier of the copy group to which belongs the copy pair which is identified by the copy pair ID 12105. The storage system 300 manages a copy group including one or more copy pairs. Thus, the management computer 100 can collectively command the temporary suspension, resumption, temporary synchronization, or cancellation of the operation of local copy or remote copy to a copy pair contained in the group by designating that copy group. The copy type 12107 is the type of copy that is executed to the copy pair which is identified by the copy pair ID 12105. For example, the copy type 12107 shows either a local copy or a remote copy.

FIG. 14 is a configuration diagram of the volume management information 1250 stored in the storage system 300 in the first embodiment.

The volume management information 1250 includes a logical volume ID 12501, a volume status 12502, a capacity 12503, a copy pair ID 12504, a group ID 12505, areal volume ID 12506, and a virtual flag 12507.

The logical volume ID 12501 is a unique identifier of the logical volume that is provided by the storage system 300 storing the volume management information 1250. The volume status 12502 shows the current status of the logical volume which is identified by the logical volume ID 12501. For example, the volume status 12502 shows at least one among primary volume, secondary volume, normal, abnormal, or not loaded. More specifically, for example, if the logical volume that is identified by the logical volume ID 12501 is a primary volume, the volume status information 12502 shows the “primary volume”. Moreover, if the logical volume that is identified by the logical volume ID 12501 is a secondary volume, the volume status information 12502 shows the “secondary volume”. Moreover, if the host computer 200 can normally access the logical volume that is identified by the logical volume ID 12501, the volume status information 12502 shows “normal”. Moreover, if the host computer 200 is unable to normally access the logical volume that is identified by the logical volume ID 12501, the volume status information 12502 shows “abnormal”. For example, during the malfunction of the disk drive 1500 or during the failure of copy, the volume status information 12502 shows “abnormal”. Moreover, if data is not stored in the logical volume which is identified by the logical volume ID 12501, the volume status information 12502 shows “not loaded”.

The capacity 12503 shows the capacity (storage capacity) of the logical volume which is identified by the logical volume ID 12501. The copy pair ID 12504 is a unique identifier of the copy pair containing the logical volume which is identified by the logical volume ID 12501. The group ID 12505 is a unique identifier of the copy group to which belongs the copy pair which is identified by the copy pair ID 12505. The real volume ID 12506 is an identifier indicating the virtual volume or real volume corresponding to the logical volume which is identified by the logical volume ID 12501. The virtual flag 12507 shows whether the logical volume is configured from a virtual volume (for example, flag is 1) or not (for example, flag is 0). If the flag is 1, it means that the logical volume is a virtual logical volume. Moreover, if the flag is 0, it means that the logical volume is a real logical volume.

FIG. 15 is a configuration diagram of the virtual logical volume management information 1270 stored in the storage system 300 in the first embodiment.

The virtual logical volume management information 1270 is information concerning the virtual logical volume. The virtual logical volume management information 1270 exists in the same number as the number of virtual logical volumes retained by the storage system 300. In other words, the virtual logical volume management information 1270 and the virtual logical volume correspond one-to-one. The virtual logical volume management information 1270 includes a volume ID 12701, a pool ID 12703 and address maps (12704, 12705, 12706). In the ensuing explanation, the storage system 300 storing the virtual volume information 1270 is referred to as “this storage system 300” and the virtual logical volume corresponding to the virtual logical volume management information 1270 is referred to as “this virtual volume”.

The volume ID 12701 is an identifier of the real volume which is uniquely shown by this storage system 300. The pool ID 12703 is an identifier which uniquely shows the storage hierarchy pool management information 1290 managed by this storage system 300. The pool ID 12703 is used for identifying the real volume group providing pages to this virtual logical volume.

The address maps are configured from a virtual address 12704, a hierarchy address pointer 12705, and an update flag 12706. The virtual address 12704 is an extent address indicating a virtual area of a single unit in the virtual logical volume. The size of a virtual area of a single unit is the same size of a page. If a virtual logical volume is designated in the IO request from the host computer 200, the virtual address representing the virtual area of the access destination in the virtual logical volume is also designated. The hierarchy address pointer 12705 is a pointer indicating one area of the storage hierarchy address map of a specific hierarchy of the storage hierarchy pool management information 1290 which is indicated by the pool ID 12703. In other words, the storage hierarchy pool management information 1290 includes several hierarchies, and each hierarchy contains a storage hierarchy address map. In addition, the storage hierarchy address map provides a linear storage area, and designates the hierarchy number within that pool and one address of the storage hierarchy address map which is provided for each hierarchy number based on the hierarchy address pointer 12705. Note that, when a page is not assigned to a virtual area, the hierarchy address pointer 12705 corresponding to the virtual address 12704 of that virtual area becomes information showing “unused”. The update flag 12706 is a flag showing that writing was performed to the area (page) indicated by this virtual address.

FIG. 16 is a configuration diagram of the storage hierarchy pool management information 1290 stored in the storage system 300 in the first embodiment.

The storage hierarchy pool management information 1290 is information for managing the pools. The storage hierarchy pool management information 1290 exists in the same number as the number of pools in this storage system 300. In other words, the storage hierarchy pool management information 1290 and the pool correspond one-to-one. The storage hierarchy pool management information 1290 includes a pool ID 12901, and storage hierarchy address map information (12902 to 12909). The pool corresponding to this storage hierarchy pool management information 1290 is hereinafter referred to as “this pool”. The pool ID 12901 is an identifier which uniquely shows this pool. The storage hierarchy address map information is information for managing one or more real volumes assigned to the one or more hierarchies existing in this pool. The storage hierarchy address map information exists in the same number as the number of hierarchies registered in this pool, and enables the reference to the storage area of the respective hierarchies using a linear address. The storage hierarchy address map information includes a hierarchy number 12902, total number of real volumes 12903, total capacity information 12904, total unused capacity information 12905, an address 12906, assignment information 12907, a volume ID 12908, and a real address 12909. The real volume corresponding to this storage hierarchy address map information is hereinafter referred to as “this real volume”.

The hierarchy number 12902 is a number representing the hierarchy of the storage hierarchy. The total number of real volumes 12903 indicates the number of real volumes that are registered in the hierarchy indicated by the hierarchy number. The total capacity information 12904 indicates the total capacity of the real volumes that are registered in the hierarchy indicated by the hierarchy number. The total unused capacity 12905 indicates the total capacity of the unused areas to which a page has not been assigned in the real volumes that are registered in the hierarchy indicated by the hierarchy number. The volume ID 12902 is a unique identifier of this real volume. The address 12906 represents the address of a linear address space that is provided by the storage hierarchy address map. The assignment information 12907 shows whether an area corresponding to the address 12906 has been assigned or has not been assigned (in other words, whether it is assignable or not assignable), and, if the area has been assigned, represents information (access frequency) concerning how many times such area was referred to after being assigned. The volume ID 12908 is a unique identifier of the real volume. The real address 12909 indicates an address in the real volume indicated by the real volume ID.

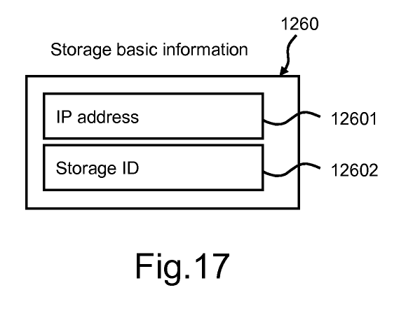

FIG. 17 is a configuration diagram of the storage basic information 1260 stored in the storage system 300 in the first embodiment.

The storage basic information 1260 includes an IP address 12601 that is given to the storage system 300, and a storage ID 12602. The IP address 12601 is an IP address that is given to the storage system 300. The storage ID 12602 is a unique identifier of the storage system indicated by the IP address 12601.

FIG. 18 is a diagram explaining the configuration of the request 7300.

The IO request 7300 is issued by the management computer 100 or the host computer 200. The IO request 7300 includes an address 73001, a command description 73002, a serial number 73003, a group ID 73004, and an option 73005.

The address 73001 is information concerning the address regarding the IO request 7300. The address 73001 is information containing, for example, the identifier of the storage system 300 to become the destination of the IO request 7300, the identifier of the logical volume (for example, virtual logical volume or real logical volume) in that storage system 300, and the address (volume address) of the storage area (for example, virtual area or real area) in that logical volume.

The command description 73002 shows the contents of the processing that are commanded in the IO request 7300. For example, the command description 73002 is a control command of local copy or remote copy, a data access command, or the like. As the control command of local copy or remote copy, for example, there is new local copy start, local copy add, local copy close, new remote copy start, remote copy add, remote copy close, restoration preparation, high-speed restoration, normal restoration (restoration preparation, high-speed restoration and normal restoration are common to local copy and remote copy), high-order hierarchy migration, low-order hierarchy migration, or status acquisition. Moreover, as the data access command, for example, there is data writing or data referral.

The serial number 73003 shows the order that the IO request 7300 is issued. Thus, the serial number 73003 is decided by the management computer 100 or the host computer 200 as the issuer of the IO request 7300. The group ID 73004 is a unique identifier of the copy group to be subject to processing based on the IO request 7300. The option 73005 is copy configuration information, option information which assists the IO request 7300, data which is requested to be written based on the IO request 7300, and so on. Note that the copy configuration information includes a copy type, a storage ID of the copy destination, a real logical volume ID or a virtual logical volume ID of the copy source, a storage ID of the copy destination, a real logical volume ID or a virtual logical volume ID of the copy source, and so on.

The operation of the storage system 300 is now explained.

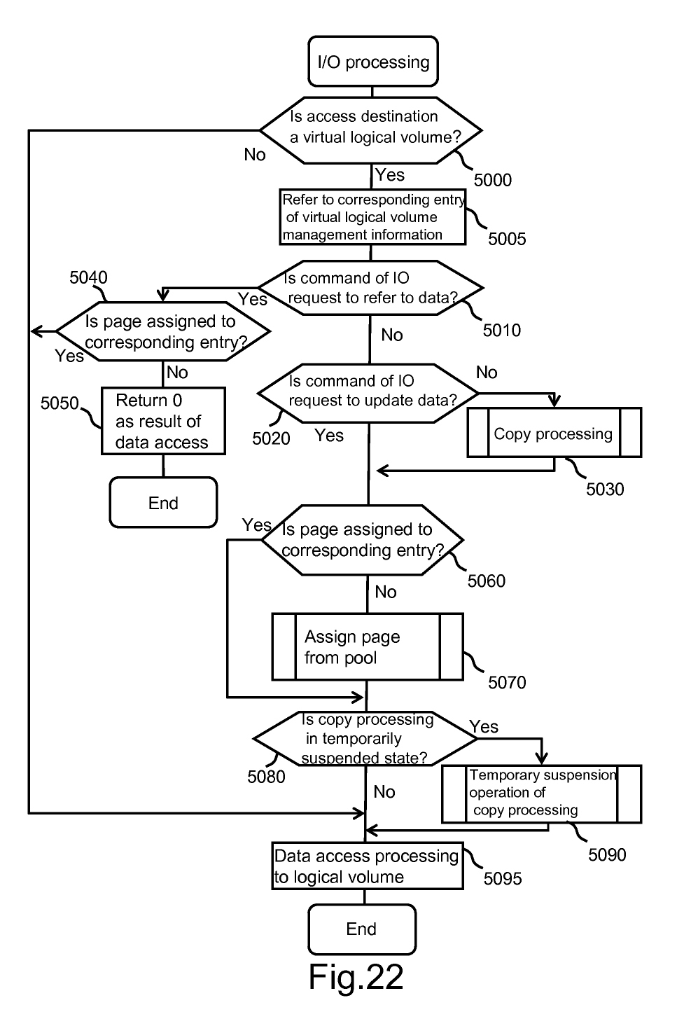

FIG. 22 is an example of the flowchart of the data access processing in the storage system 300 in the first embodiment.

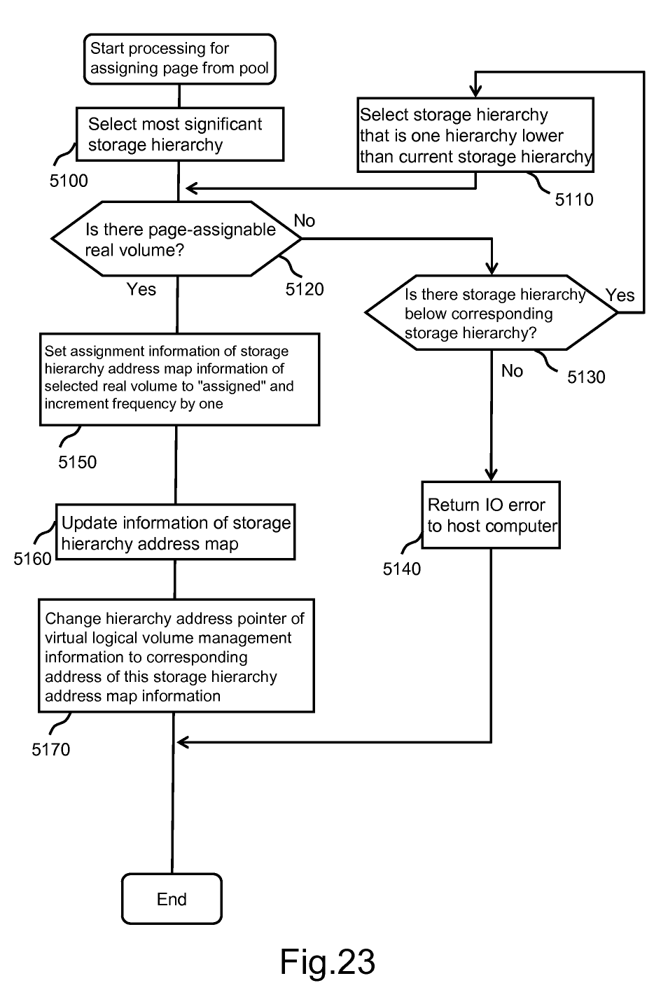

When the I/O control unit 1300 of the storage system 300 receives an IO request 7300 from the host computer 200, it determines whether the address 73001 of that IO request 7300 represents a virtual logical volume (step 5000). Specifically, for example, the processor 1310 of the I/O control unit 1300 (hereinafter referred to as the “I/O control unit 1300”) refers to the address 73001 of the IO request 7300, and acquires the volume ID contained in the address 73001. Subsequently, the I/O control unit 1300 acquires, from the volume management information 1250, information concerning the logical volume which coincides with the acquired volume ID. If the virtual flag 12507 of that volume management information 1250 represents a virtual logical volume (Yes in step 5000), the I/O control unit 1300 executes step 5005 onward, and if it does not represent a virtual logical volume (No in step 5000), executes step 5095. The virtual logical volume corresponding to the foregoing acquired volume ID is referred to as “this virtual logical volume” in the explanation of FIG. 22 and FIG. 23.

In step 5005, the I/O control unit 1300 refers to the virtual logical volume management information 1270 including the volume ID 12701 which coincided with the foregoing acquired volume ID from the one or more types of virtual logical volume management information 1270. The identified virtual logical volume management information 1270 is hereinafter referred to as “this virtual logical volume management information 1270” in the explanation of FIG. 22 and FIG. 23.

Subsequently, the I/O control unit 1300 identifies the virtual address 12704 which coincided with the volume address (hereinafter referred to as “this volume address” in the explanation of FIG. 22 and FIG. 23) contained in the address 73001 of the IO request 7300 from this virtual logical volume management information 1270. The I/O control unit 1300 refers to the virtual address entry corresponding to the identified virtual address 12704. Here, a virtual address entry is the entry that is configured from the virtual address 12704, the hierarchy address pointer 12705, and the update flag 12706.

The I/O control unit 1300 checks whether the command description 73002 of the IO request 7300 is data referral (step 5010). If it is not data referral (No in step 5010), the I/O control unit 1300 additionally determines whether the command description 73002 of the IO request 7300 is data update (step 5020).

As a result of the determination in step 5020, if the command description 73002 of the IO request is not data update (No in step 5020), the I/O control unit 1300 implements the processing according to the command described in the IO request; that is, the processing (step 5030) of the respective storage functions such as copy processing, storage hierarchy processing and the like. Note that the copy processing (step 5030) will be described later.

As a result of the determination in step 5020, if the command description 73002 of the IO request is data update (Yes in step 5020), or after the completion of the processing (step 5030) of the respective storage functions, the I/O control unit 1300 refers to the hierarchy address pointer 12705 in this virtual address entry (step 5060). As a result of the referral, if the hierarchy address pointer 12705 shows “unused” (there is no assigned page) (No in step 5060), the I/O control unit 1300 implements the processing (step 5070) of assigning a page from a pool. The processing (step 5070) of assigning a page will be described in detail later.

Here, in the determination in step 5010, if the command description 73002 in the IO request 7300 is data referral (Yes in step 5010), the I/O control unit 1300 refers to the hierarchy address pointer 12705 of this virtual address entry. As a result of this referral, if the hierarchy address pointer 12705 shows “unused” (there is no assigned page) (No in step 5040), the I/O control unit 1300 returns “0” to the host computer 200 with the result of the data referral based on the IO request 7300 being “0” (in other words, since a data element representing “0” was read) (step 5050), and thereby ends the data access processing.

After the processing (step 5070) of assigning a page from a pool, or the hierarchy address pointer 12705 does not show “unused” (if there is an assigned page) in the determination in step 5060 (Yes in step 5060), the I/O control unit 1300 refers to the copy pair management information 1210, and detects copy pair management information 1210 containing this virtual logical volume and in which its copy status 12102 is a temporary suspension (step 5080).

If there is copy pair management information 1210 containing this virtual logical volume and in which its copy status 12102 is a temporary suspension (Yes in step 5080), the I/O control unit 1300 implements the temporary suspension operation of the various types of copy processing (step 5090).

If the conditions are not satisfied in the determination in step 5080 (No in step 5080), if the hierarchy address pointer 12705 does not show “unused” in the determination in step 5040 (Yes in step 5040), or if the virtual flag 12507 of the volume management information 1250 does not represent a virtual logical volume (No in step 5000), the I/O control unit 1300 implements the data access processing (step 5095) to that logical volume (virtual logical volume or real logical volume). In the data access processing to the logical volume, if the logical volume represented by the address 73001 of the IO request 7300 is a virtual logical volume, the I/O control unit 1300 accesses the page that was identified by the hierarchy address pointer 12705 of this virtual address entry. Moreover, if the logical volume represented by the address 73001 of the IO request 7300 is a real logical volume, the I/O control unit 1300 accesses the real area that was identified by the volume address in the address 73001.

The foregoing was an example of the flow of the data access processing. Note that, in the explanation of FIG. 22, the processing performed by the I/O control unit 1300 can also be performed, for example, by the processor 1310 to execute the I/O processing program 1240. The processor 1310 can perform the processing concerning the virtual volume by executing the virtual volume processing program 1220.

FIG. 23 is an example of the flowchart of the page assignment processing (step 5070) for assigning a page from a pool in the storage system 300 in the first embodiment.

The I/O control unit 1300 of the storage system 300 refers to the storage hierarchy pool management information 1290 indicated by the pool ID 12703 in the virtual logical volume management information 1270 of this virtual logical volume. Subsequently, the I/O control unit 1300 selects the hierarchy with the smallest hierarchy number (most significant hierarchy that is set as having the highest performance and reliability) among the one or more types of storage hierarchy address map information (step 5100).

Subsequently, the I/O control unit 1300 determines whether any one of the assignment information 12907 among the storage hierarchy address map information of this hierarchy number shows “unused” (step 5120).

Here, as a result of step 5120, if an entry (row of the storage hierarchy address map information configured from the address 12906, the assignment information 12907, the volume ID 12908, and the real address 12909) with “unused” in any assignment information 12907 of the storage hierarchy address map information is discovered (Yes in step 5120), the I/O control unit 1300 refers to the information of that entry, acquires the volume ID 12908 and the real address 12909, and identifies the page to be accessed. In addition, the I/O control unit 1300 changes the assignment information 12907 of that entry to “assigned,” and further adds one to the value of the access frequency contained in that information (step 5150).

Subsequently, the I/O control unit 1300 deletes a capacity worth the page capacity from the total unused capacity of the total unused capacity information 12905 of this storage hierarchy address map information (step 5160).

Subsequently, the I/O control unit 1300 changes the hierarchy address pointer 12705 of the virtual logical volume management information 1270 to this entry. The hierarchy address pointer 12705 is configured from the hierarchy number 12902 and the address 12906 of the storage hierarchy pool management information 1290.

Meanwhile, as a result of the determination in step 5120, if none of the assignment information 12907 of the storage hierarchy address map information contains “unused” (No in step 5120), the I/O control unit 1300 confirms whether there is storage hierarchy address map information that is one hierarchy lower (current hierarchy number+1) than the hierarchy number of this storage hierarchy address map information (step 5130).

If there is storage hierarchy address map information that is one hierarchy lower (Yes in step 5130), the I/O control unit 1300 selects the storage hierarchy address map information (current hierarchy number+1) that is one hierarchy lower than at present (step 5110), and implements step 5120 once again.

If there is no storage hierarchy address map information that is one hierarchy lower (No in step 5130), the I/O control unit 1300 returns an IO error to the host computer 200 as the issuer of the IO request (step 5140). Here, the I/O control unit 1300 may also notify the user via the management terminal 1600 or email in addition to returning an IO error to the host computer 200.

The foregoing was an example of the flow of the page assignment processing. Note that, in the explanation of FIG. 23, the processing performed by the I/O control unit 1300 can also be performed, for example, by the processor 1310 to execute the I/O processing program 1240. The processor 1310 can perform the processing concerning the virtual volume by executing the virtual volume processing program 1220.

The operation of copy processing executed by the storage system 300 is now explained.

The outline of the local copy processing that is used in this embodiment is now explained. The local copy processing is classified into two types; namely, a clone and a snapshot. With a clone, the logical volumes of the copy source and copy destination become the same capacity and same data immediately after replication.

Meanwhile, with a snapshot, data existing in the location storing the update data received after the copy source started the copy processing is replicated in the copy destination logical volume (secondary volume). When the host computer 200 is to perform reading and writing from and to the secondary volume, data in the secondary volume is used upon referring to data in the location where data has been replicated in the secondary volume, and the primary volume is referred to upon referring to (reading) data that has not been replicated in the secondary volume. Moreover, when the host computer 200 is to write data that has not been replicated in the secondary volume, update data is additionally written from the host computer in the corresponding location of the secondary volume. Note that the operation of local copy is continued from the time that the copy processing is started with the start processing up to the time that the cancel processing is implemented.

### (Operation of Local Copy Start Processing Based on Clone)

The local copy start processing based on a clone executed by the storage system 300 is now explained.

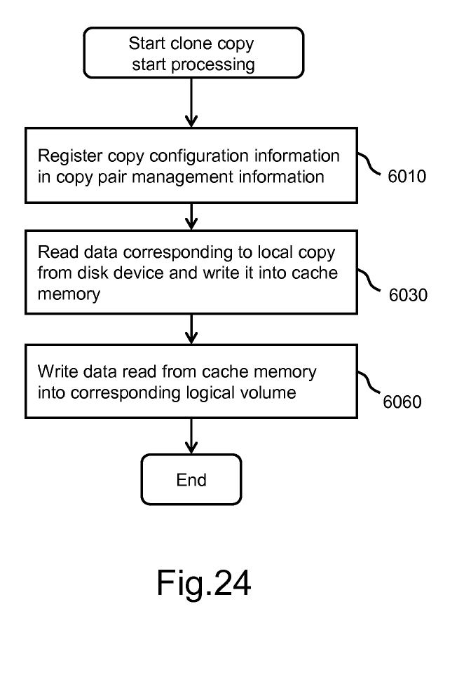

FIG. 24 is an example of the flowchart of the local copy start processing based on a clone to be executed by the storage system 300 in the first embodiment.

The start processing of local copy is the processing of replicating, in the secondary volume, the data in the primary volume of the copy target at that time that the start command was received from the management computer 100. When the replication to the secondary volume is complete, the copy processing proceeds to the “temporary suspension” of temporarily suspending the replication of data.

Foremost, when the processor 1310 of the I/O control unit 1300 of the storage system 300 (hereinafter referred to as the “I/O control unit 1300”) receives an IO request 7300 (however, clone is designated as the option) commanding the start of local copy, copy processing is started.

Subsequently, the I/O control unit 1300 creates the copy pair management information table 1210 (refer to FIG. 13) based on the copy configuration information contained in the IO request 7300 (step 6010). Specifically, the I/O control unit 1300 stores “copying” in the copy status information 12102 of the copy pair management information table 1210. Subsequently, the I/O control unit 1300 stores the copy source logical volume ID indicated in the IO request, as the copy source logical volume, in the logical volume ID 12101 of the copy pair management information table 1210.

Subsequently, the I/O control unit 1300 stores the storage ID of the copy destination contained in the copy configuration information extracted from the IO request in the copy target storage ID 12103 of the copy pair management information table 1210. Subsequently, the I/O control unit 1300 stores the copy destination logical volume ID contained in the copy configuration information extracted from the IO request in the copy target volume ID 12104 of the copy pair management information table 1210.

Subsequently, the I/O control unit 1300 stores a value that does not overlap with the other copy pair IDs in the copy pair ID 12105 of the copy pair management information table 1210. Subsequently, the I/O control unit 1300 stores the copy group ID contained in the IO request in the group ID 12106 of the copy pair management information table 1210. Subsequently, the I/O control unit 1300 stores the copy type information contained in the extracted copy configuration information in the copy type 12107 of the copy pair management information table 1210. Here, “local copy, clone” is stored in the copy type 12107.

Subsequently, the I/O control unit 1300 reads data from the logical volume that was identified by the volume ID 12101 of the copy pair management information table 1210. In addition, the I/O control unit 1300 stores the read data in the cache memory 1100 (step 6030).

Subsequently, the I/O control unit 1300 reads data from the cache memory 1100, and further writes the data that was read from the cache memory 1100 into the logical volume that is identified by the copy target volume ID 12104 of the copy pair management information table 1210 (step 6060).

The I/O control unit 1300 stores all data of the copy source logical volume in the copy destination logical volume by repeatedly executing step 6030 to step 6060.

The I/O control unit 1300 thereby ends the local copy processing based on a clone. When the local copy is complete, the I/O control unit 1300 stores “temporary suspension” in the copy status information 12102 of the copy pair management information table 1210. The I/O control unit 1300 continues implementing the temporary suspension processing.

### (Operation of Local Copy Temporary Suspension Processing Based on Clone)

The operation of the local copy temporary suspension processing based on a clone that is executed by the storage system 300 is now explained. This corresponds to step 5090 in the flowchart of FIG. 22.

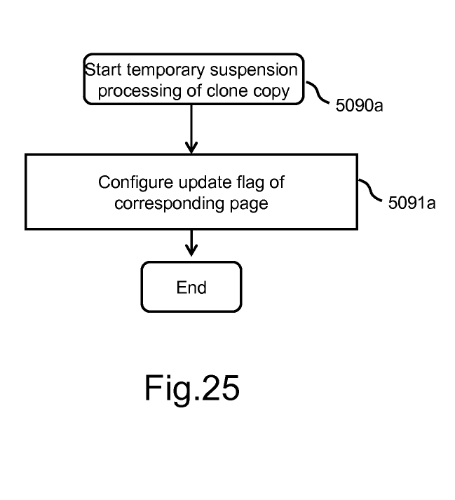

FIG. 25 is an example of the flowchart of the operation during temporary suspension of the local copy based on a clone in the first embodiment.

Here, in step 5900 of the flowchart of FIG. 22, the copy processing (local copy based on clone) is running on the storage system 300, and, in addition, if its processing status is temporary suspension, the I/O control unit 1300 of the storage system 300 implements the temporary suspension processing based on the copy function.

In the case of the local copy temporary suspension processing based on a clone (processing 5090a), the I/O control unit 1300 configures the update flag 12706 of the corresponding page in the virtual logical volume management information 1270 of this virtual logical volume as “updated” (step 5091a).

### (Operation of Local Copy Temporary Synchronization Processing Based on Clone)

The operation of the local copy temporary synchronization processing based on a clone that is executed by the storage system 300 is now explained. This processing is performed when the copy processing is running on the storage system 300 and its processing status is “temporary suspension”. Moreover, this operation corresponds to step 5030 in the flow of FIG. 22, and is started when the storage system 300 receives a “temporary synchronization” command from the management computer 100.

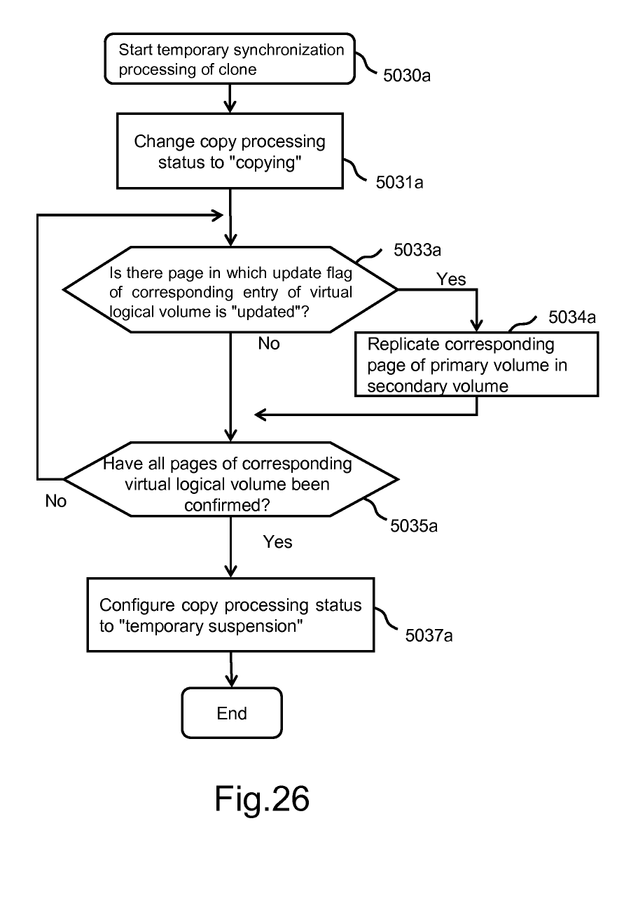

FIG. 26 is an example of the flowchart of the operation of temporary synchronization of the local copy based on a clone in the first embodiment.

Foremost, when the I/O control unit 1300 of the storage system 300 receives a “temporary synchronization” command from the management computer 100 (step 5030a), it changes the copy processing status 12102 of the corresponding copy pair management information 1210 to “copying” (step 5031a). Subsequently, the I/O control unit 1300 refers to the entries, from the higher order, of the address map of the virtual logical volume management information 1270 concerning the logical volume that was designated in the logical volume ID 12101 of the copy pair management information 1210, and confirms whether the update flag 12706 is “updated” (step 5033a).

When the update flag 12706 of the corresponding entry is “updated” (Yes in step 5033a), the I/O control unit 1300 replicates the data element of the corresponding page of the virtual logical volume management information 1270, and stores this in the same address of the secondary volume (step 5034a).

When the update flag 12706 of the corresponding entry is not “updated” (No in step 5033a), or if step 5034a is complete, the I/O control unit 1300 confirms whether the confirmation of all entries of this virtual logical volume management information 1270 is complete (step 5035a).

When the confirmation of all entries of this virtual logical volume management information 1270 is not complete (No in step 5035a), the I/O control unit 1300 once again implements the processing from step 5033a for the subsequent entry.

When the confirmation of all entries of this virtual logical volume management information 1270 is complete (Yes in step 5035a), the I/O control unit 1300 re-configures the copy status information 12102 of the copy pair management information 1210 to “temporary suspension” (step 5037a). In addition, the I/O control unit 1300 configures all update flags 12706 of the virtual logical volume management information 1270 concerning the logical volume registered in the logical volume ID 12101 of the copy pair management information 1210 to “no update,” and thereby ends the copy processing of temporary synchronization.

### (Operation of Local Copy Processing Based on Snapshot)

The local copy processing based on a snapshot executed by the storage system 300 is now explained.

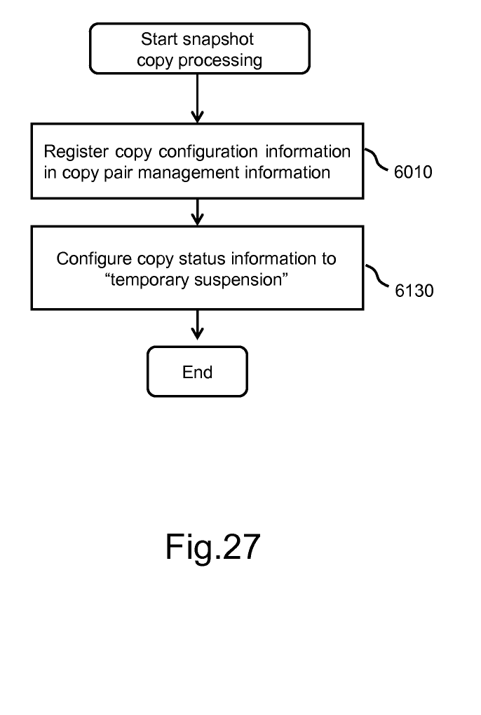

FIG. 27 is an example of the flowchart of the operation of starting the local copy based on a snapshot in the first embodiment.

The I/O control unit 1300 of the storage system 300 implements basically the same procedures as the local copy based on a clone for the local copy processing based on a snapshot. Only the different processing is explained below.

When the I/O control unit 1300 receives an IO request 7300 (however, snapshot is designated as the option) commanding the start of local copy, it starts the copy processing and executes the processing of step 6010. The processing of step 6010 is the same as the logical copy processing based on a clone other than that the option is a snapshot and not a clone.

The I/O control unit 1300 thereby ends the local copy processing based on a snapshot. When the I/O control unit 1300 ends the local copy, it stores “temporary suspension” in the copy status information 12102 of the copy pair management information table 1210 (step 6130).

### (Operation of Local Copy Temporary Suspension Processing Based on Snapshot)

The local copy temporary suspension processing based on a snapshot that is executed by the storage system 300 is now explained. This corresponds to step 5090 in the flowchart of FIG. 22.

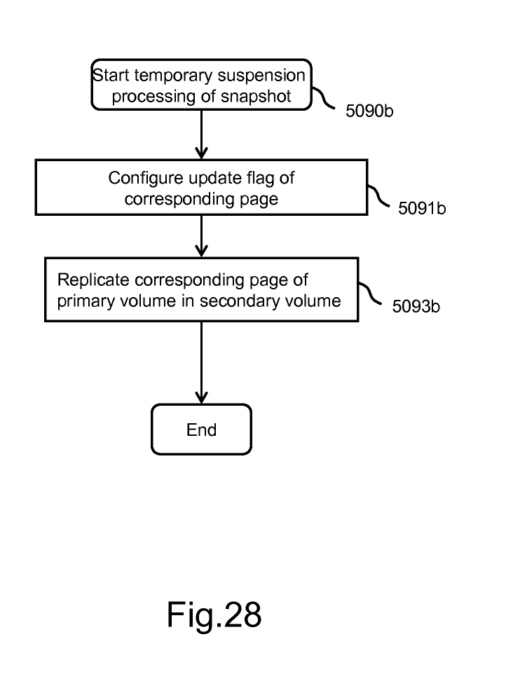

FIG. 28 is an example of the flowchart of the operation during temporary suspension of the local copy based on a snapshot in the first embodiment.

Here, in step 5090 of the flowchart of FIG. 22, the copy processing (local copy based on snapshot) is running on the storage system 300, and, in addition, if its processing status is temporary suspension, the I/O control unit 1300 of the storage system 300 implements the temporary suspension processing based on the copy function.

In the case of the local copy temporary suspension processing based on a snapshot (processing 5090b), the I/O control unit 1300 configures the update flag 12706 of the corresponding page in the virtual logical volume management information 1270 of this virtual logical volume as “updated” (step 5091b).

In addition, the I/O control unit 1300 replicates the data element indicating the corresponding page of the virtual logical volume management information 1270, and stores this in the same address of the secondary volume (step 5093b).

### (Operation of Local Copy Temporary Synchronization Processing Based on Snapshot)

The local copy temporary synchronization processing based on a snapshot that is executed by the storage system 300 is now explained. This processing is performed when the copy processing is running on the storage system 300 and its processing status is “temporary suspension”. Moreover, this operation corresponds to step 5030 in the flowchart of FIG. 22, and is started when the storage system 300 receives a “temporary synchronization” command from the management computer 100.

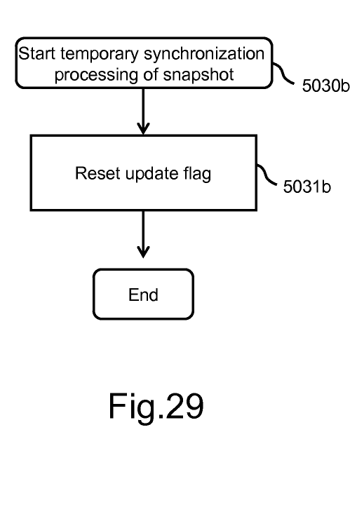

FIG. 29 is an example of the flowchart of the operation of temporary synchronization of the local copy based on a snapshot in the first embodiment.

Foremost, when the I/O control unit 1300 of the storage system 300 receives a “temporary synchronization” command from the management computer 100 (step 5030b), it configures all update flags 12706 of all entries of the address map of the virtual logical volume management information 1270 concerning the logical volume 12101 of the corresponding copy pair management information 1210 to “no update” (step 5031b). Subsequently, the I/O control unit 1300 ends the copy processing of temporary synchronization.

### (Operation of Restoration Processing Based on Snapshot/Clone)

The operation of the restoration processing based on a snapshot and clone that is executed by the storage system 300 is now explained. The restoration processing is the processing of overwriting the primary volume with the contents of the secondary volume.

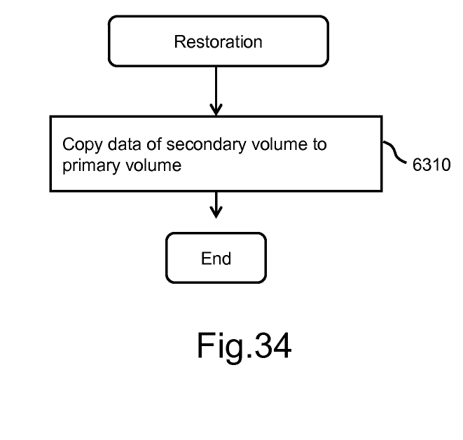

FIG. 34 is an example of the flowchart of the operation of restoring the snapshot and clone executed by the storage system 300 in the first embodiment.

Foremost, when the I/O control unit 1300 of the storage system 300 receives a “restoration” command from the management computer 100, it implements the restoration processing of the primary volume indicated by the logical volume 12101 of the corresponding copy pair management information 1210.

Subsequently, the I/O control unit 1300 changes the copy status information 12102 of the copy pair management information 1210 to “copying,” and overwrites the primary volume with the data stored in the copy target volume ID 12104 of the copy pair management information 1210 (step 6310). After the foregoing is complete, the I/O control unit 1300 changes the copy status information 12102 to “temporary suspension” and thereby ends the processing.

### (Operation of Quick Restoration Processing Based on Snapshot/Clone)

The operation of the quick restoration processing based on a snapshot and clone that is executed by the storage system 300 is now explained. The quick restoration processing is processing of realizing data access to the secondary volume by switching the access of the host computer 200 from the primary volume to the secondary volume.

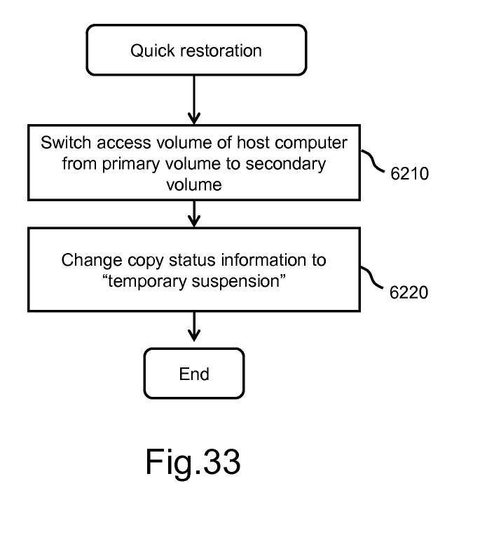

FIG. 33 is an example of the flowchart of the operation of the quick restoration which is common to the snapshot and clone executed by the storage system 300 in the first embodiment.

Foremost, when the I/O control unit 1300 of the storage system 300 receives a “quick restoration” command from the management computer 100, it implements the quick restoration processing of the secondary volume indicated by the copy target volume ID 12104 of the corresponding copy pair management information 1210.

The I/O control unit 1300 changes the copy status information 12102 of the copy pair management information 1210 to “copying,” and switches the logical volume ID 12101 and the copy target volume ID 12104 of the copy pair management information 1210 (step 6210).

Subsequently, after the foregoing is complete, the I/O control unit 1300 changes the copy status information 12102 to “temporary suspension” (step 6220), enables the logical volume that was conventionally a secondary volume to be accessed by the host computer 200 as a primary volume, and thereby ends the quick restoration processing.

The operation of the storage hierarchy control processing that is executed by the storage system 300 in the first embodiment of the present invention is now explained. The storage hierarchy control processing is the processing which is implemented periodically or based on a user's command for migrating pages, which are stored in real volumes with different hierarchies, between hierarchies.

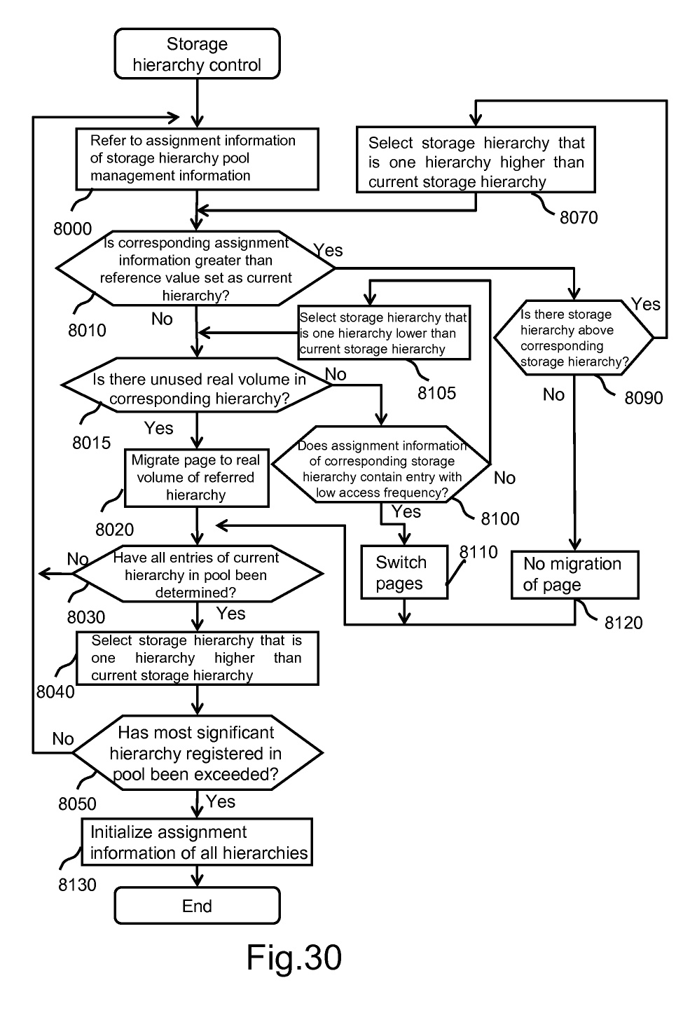

FIG. 30 is an example of the flowchart of the storage hierarchy control processing in the first embodiment. This flowchart is based on the premise of the storage hierarchy control that is periodically implemented. The storage hierarchy control in the respective pools is explained below.

Foremost, the I/O control unit 1300 of the storage system 300 refers to the assignment information 12907 of the storage hierarchy pool management information 1290 of the designated pool (step 8000). Here, the I/O control unit 1300 refers to the entries in order from the most significant entry of the storage hierarchy address map information of the least significant hierarchy. In the ensuing explanation, the hierarchy that is currently being referred to by the I/O control unit 1300 is referred to as the source hierarchy, and the entry of the storage hierarchy address map information of the source hierarchy of the storage hierarchy pool management information 1290 is referred to as the source entry.

Subsequently, the I/O control unit 1300 compares the reference access frequency (reference value) that is defined relative to the source hierarchy and the access frequency described in the assignment information 12907 of the corresponding entry (step 8010). Here, with the storage hierarchy control, the access frequency (reference access frequency) as the reference is defined in advance in the respective hierarchies by the user or the like. Whether to migrate a page between real volumes with different hierarchies is determined based on whether the foregoing reference access frequency is exceeded.

When the access frequency of the assignment information 12907 of the source entry exceeds the reference value (Yes in step 8010), and if there is additionally a higher order hierarchy in the source hierarchy (Yes in step 8090), the I/O control unit 1300 selects a hierarchy that is one hierarchy higher than the source hierarchy (step 8070), and compares it with the reference value of that hierarchy (step 8010). The I/O control unit 1300 repeats these steps in order to identify a hierarchy that does not exceed the reference value. Here, a hierarchy that does not exceed the reference value is hereinafter referred to as the target hierarchy, and an entry in the storage hierarchy address map information to be searched in the target hierarchy is hereinafter referred to as the target entry. Note that, if there is no higher order hierarchy in the source hierarchy in step 8090 (No in step 8090), the corresponding page is not migrated (step 8120), and the routine proceeds to step 8030.

Subsequently, upon identifying the hierarchy (target hierarchy) that does not exceed the reference value (No in step 8010), the I/O control unit 1300 refers to the total unused capacity 12905 of the storage hierarchy address map information of the target hierarchy, and confirms whether there is an unused real volume in the target hierarchy to which the page can be migrated (step 8015).

If there is no unused space in the target hierarchy (No in step 8015), the I/O control unit 1300 determines whether there is an entry of an access frequency in the target hierarchy that is lower than the access frequency of the assignment information 12907 of the source entry (step 8100).

Here, if there is no entry of an access frequency in the target hierarchy that is lower than the access frequency of the assignment information 12907 of the source entry (No in step 8100), the hierarchy that is one hierarchy lower than the target hierarchy is configured as the target hierarchy, and whether there is an unused space in the target hierarchy is confirmed (step 8100).

If there is an entry of an access frequency in the target hierarchy that is lower than the access frequency of the assignment information 12907 of the source entry (Yes in step 8100), the pages of the source entry and the target entry are switched (step 8110).

Meanwhile, if there is an unused real volume in the target hierarchy to which the page can be migrated (Yes in step 8015), the I/O control unit 1300 migrates the pages to the unused real volume in the target hierarchy (step 8020).

After implementing step 8020, step 8110, or step 8120, the I/O control unit 1300 confirms whether the determination was implemented regarding all source entries of the source hierarchy in the pool (step 8030), and, if there is an entry that has not yet been determined, processing is implemented once again from step 8000 (No in step 8030).

If there is no entry that has not yet been determined in step 8030, a hierarchy that is one hierarchy higher than the source hierarchy is configured as the source hierarchy (step 8040). Here, if there is a hierarchy that is one hierarchy higher than the source hierarchy (No in step 8050), the I/O control unit 1300 implements processing once again from step 8000.

If there is no hierarchy that is one hierarchy higher than the source hierarchy (Yes in step 8050), the I/O control unit 1300 resets the access frequency of the assignment information 12907 in the storage hierarchy address map information of all hierarchies in the pool to 0 (step 8130).

The management operation of the computer system in the management computer 100 is now explained. There are three stages in the management operation of the management computer 100; specifically, the environment creation stage, the data replication stage, and the replicated data use stage.

### (1) Environment Creation Stage

The management operation of the environment creation stage by the management computer 100 in this embodiment is foremost explained. The environment creation stage is the stage of the management operation where the management computer 100 creates and configures information that is used in the data replication stage and the replicated data use stage.

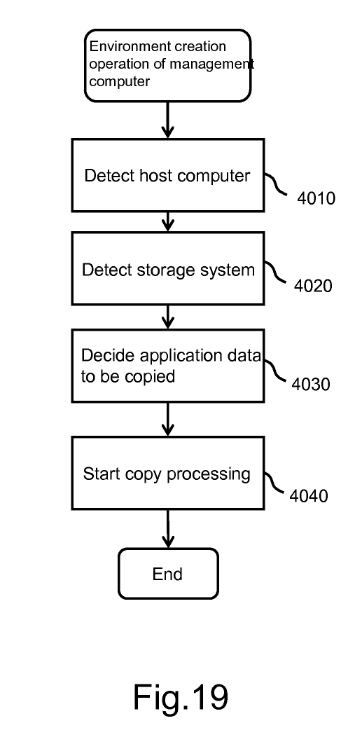

FIG. 19 is an example of the flowchart of the management operation in the environment creation stage performed by the management computer 100 in the first embodiment.

The management operation of the environment creation stage is realized by the processor 120 of the management computer 100 executing the storage management program 112. The flowchart is explained below by simply referring to the management computer 100 as the subject, but in reality all operations are implemented by the processor 120 of the management computer 100.

Foremost, the management computer 100 detects the host computer 200 existing in the computer system (step 4010). As information to be used for the detection, for example, the input of an IP address by the user of the management computer 100 is used. The input of the address may be, for example, an input of the range of the IP address such as 192.168.1.1 to 192.168.1.50, or an input of a specific IP address. The management computer 100 creates an information acquisition request for the agent program 213 of the host computer 200, and issues an information acquisition request for the input IP address. When the host computer 200 receives the information acquisition request, the configuration information of that host computer 200 is returned to the management computer 100 based on a command of the agent program 213 running on the host computer 200. The foregoing configuration information includes information concerning the application name, name of the data used by the application, logical volume storing that data, and storage address of the logical volume (storage address is, for example, LBA of SCSI or the like). The management computer 100 creates the host configuration management table 111 based on the information contained in the returned information in response to those that were returned from the host computer 200.

Subsequently, the management computer 100 detects the storage system 300 existing in the computer system (step 4020). For the detection of the storage system 300, as with step 4010, the management computer 100 creates an information acquisition request for the storage system 300 based on the IP address that was input by the user of the management computer 100. With the storage system 300, when the processor 1310 of the storage control apparatus 1000 receives the foregoing information acquisition request, it refers to the volume management information 1250 and the storage basic information 1260 stored in the shared memory 1200, and collectively returns such information. The management computer 100 creates the storage information table 114 based on the information contained in the returned information in response to those that were returned from the storage system 300.

Subsequently, the management computer 100 decides the data of the application program of the copy target. Specifically, the management computer 100 provides a management screen to the user, and makes the determination by receiving inputs with the management concerning the copy target application, the host computer 200, and that data.

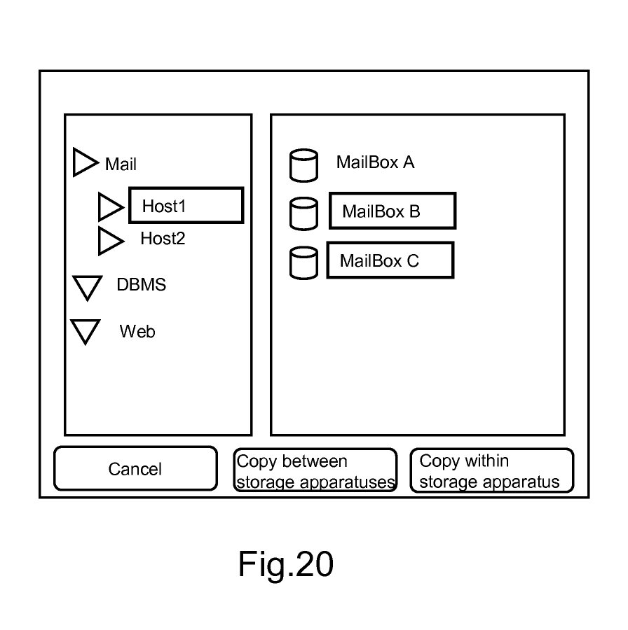

FIG. 20 is an example of the management screen for deciding the data of the copy target application program provided by the management computer 100 in the first embodiment.

The management screen illustrated in FIG. 20 shows that there are two host computers 200 on which the Mail program is running, and Mail Box B and Mail Box C as data of the host computer (Host 1) as one of such host computers has been selected as the copy target data. When the copy target data is determined, the management computer 100 identifies the storage system 300 and the logical volume (primary volume) to store such data. Specifically, this is realized by the management computer 100 referring to the host configuration management table 111 and detecting the storage ID 1115 and the volume ID 1116 which coincide with the name of that data (data name). After the copy target data is determined, the management computer 100 provides a management screen to the user for inputting the protection requirements, and acquires, from the user, information concerning the retention period, frequency of acquiring protected data, usage, and host computer using the protected data.

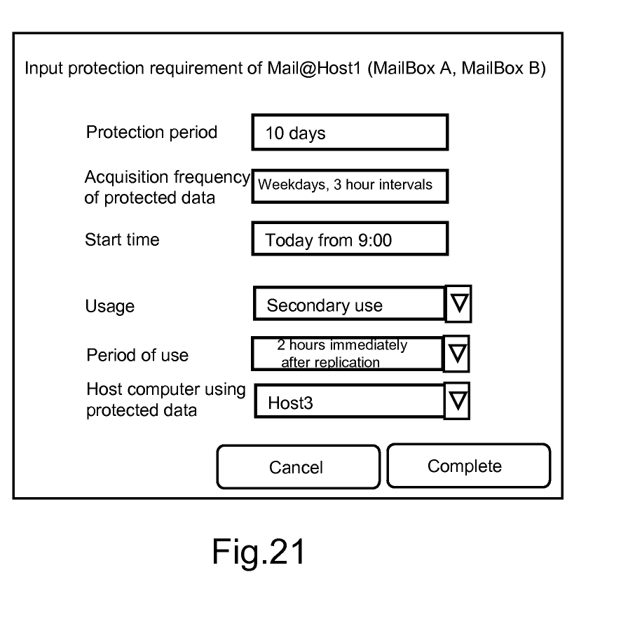

FIG. 21 is an example of the management screen for defining the protection requirements provided by the management computer 100 in the first embodiment.

In the management screen shown in FIG. 21, information concerning how long the protected data is to be retained in the system 300 is acquired based on the user's input regarding the retention period, information concerning at what frequency the copy target data is to be copied is acquired from the acquisition frequency of the protected data, information concerning the selection of secondary use or backup recovery as the purpose of copy is acquired from the input concerning the usage, and information of the host computer 200 using the logical volume storing the protected data is acquired from the input concerning the host computer using the protected data.

Subsequently, the management computer 100 decides the copy destination logical volume (secondary volume). As the secondary volume, selected is a logical volume which is not being copied among the logical volumes registered in the storage information table 114. Whether the copy processing is being performed in a logical volume is determined by the management computer 100 based on whether there is any registration in the primary volume ID 1134 and the secondary volume ID 1136 of the copy information table 113. However, if copy between storage apparatuses is selected in FIG. 20, the secondary volume is selected from the storage systems 300 which are registered in advance, and, if copy within the storage apparatus is selected, the secondary volume is selected from the storage systems 300 with the same primary volume.

Here, there are cases where the number of secondary volumes to one primary volume becomes a plurality. In order to decide the number of secondary volumes, the following calculation formula is used, for example, based on the acquisition frequency of protected data and the retention period acquired from the user via the management screen of FIG. 21. Number of secondary volumes=retention period acquisition frequency of protected data (however, the calculation result shall be an integer by rounding up to the nearest whole number). Nevertheless, the calculation formula for calculating the number of secondary volumes is not limited to the foregoing calculation formula. If there are a plurality of secondary volumes, the management computer 100 implements processing for deciding the secondary volume for the number of secondary volumes that was obtained from the calculation result. Here, the copy where the primary volume is the same and the secondary volume is different is referred to as the “generation” of the copy. For example, if there are secondary volumes 1, 2 relative to the primary volume 1, the copy configured from the primary volume 1 and the secondary volume 1 is referred to as the first generation copy, and the copy configured from the primary volume 1 and the secondary volume 2 is referred to as the second generation copy.

Subsequently, the management computer 100 creates the copy information table 113 for the number of secondary volumes (that is, for the number of generations thereof). If the button that is clicked after the data is selected in the management screen of FIG. 20 is “copy between storage apparatuses”, the management computer 100 registers remote copy in the copy information 1131 of the copy information table 113, and, if “copy within storage apparatus” was clicked, registers local copy in the copy information 1131 of the copy information table 113. Moreover, in the case of local copy, there is clone and snapshot, but the management computer 100 selects this, for example, based on the usage that was input in the management screen of FIG. 21. In other words, the management computer 100 selects clone in the case of secondary use and selects snapshot in the case of backup recovery, and configures the selected contents as the option of the copy function. Note that other methods can be used; for instance, configuring it has the initial value of the storage management program 112 in advance. However, the selection of clone and snapshot in this embodiment is not limited to the foregoing method.

The storage location of the copy target data that was selected in FIG. 20 is configured in the primary storage ID 1133 and the primary volume ID of the copy information table 113. The storage location of data can be obtained by referring to the host configuration management table 111. Moreover, the identifier of the logical volume that was selected as the logical volume which is not being copied is configured in the secondary storage ID 1135 and the secondary volume ID 1136. Generated in the group ID 1132 is a group ID of the copy function that is used by the storage system 300 to become the copy target in a value that will not overlap. The copy information table 113 is created in the same number as the number of generations, but it is also possible to affix the total number of generations and the generation number to the file name and the like of the copy information table 113 so that the management computer 100 will be able to understand the relationship of the copy information table 113 and the generations.

Subsequently, the management computer 100 creates the protected data management table 115. The serial number (initial value is 1) from the highest row is configured in the number 1150. The application name selected in the management screen of FIG. 20 is configured in the application name 1151, and the identifier of the host computer 200 selected in the management screen of FIG. 20 is configured in the host ID 1152. The start time input in the management screen of FIG. 21 is configured in the start time 1153. The acquisition frequency of protected data input in the management screen of FIG. 21 is configured in the schedule 1154. The usage input in the management screen of FIG. 21 is configured in the purpose 1155. Information (storage location 1114 and volume ID 1116) which coincided in the host configuration management table 111 is acquired based on the host computer 200 selected in the management screen of FIG. 20 and its data, and such information is collectively configured in the protected data 1156. The period of use input in the management screen of FIG. 21 is configured in the period of use 1157. The value of the calculated number of generation is configured in the number of generations 1158.

Subsequently, the management computer 100 generates an IO request 7300 from the corresponding information (copy information 1131, group ID 1132, primary storage ID 1133, primary volume ID 1134, secondary storage ID 1135, secondary volume ID 1136) of the created copy information table 113. The management computer 100 creates the IO request 7300 with the primary storage 1133 of that copy information table 113 as the address, with the command description as “new local copy start,” and with option 73005 as the copy configuration information (primary storage ID 1133, primary volume ID 1134, secondary storage ID 1135, secondary volume ID 1136, copy information 1131, group ID 1132), and issues this to the storage system 300 (step 4040).

### (2) Data Replication Stage

The management operation of the data replication stage by the management computer 100 in this embodiment is now explained. The data replication stage is the stage of the management operation of acquiring protected data based on the respective types of information configured in the environment creation stage.

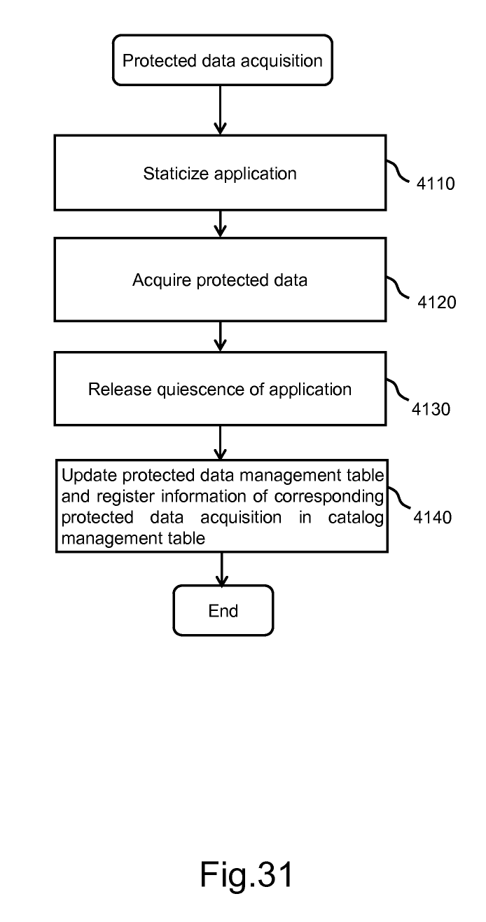

FIG. 31 is an example of the flowchart of the management operation in the data replication stage performed by the management computer 100 in the first embodiment.

Foremost, the management computer 100 refers to the protected data management table 115 and acquires the start time 1153. The management computer 100 registers the series of processes up to steps 4110, 4120, 4130 in a schedule or the management computer 100 or the like so that they are executed at the start time. As a result of registering the series of processes in the scheduler of the management computer 100, the management computer 100 starts the foregoing series of processed at the designated time. Specifically, the management computer 100 commands the quiescence of the application program 211 of the host computer 200 via the agent program 213 (step 4110). Quiescence is the processing of transforming the application program 211 or, in certain cases, the OS 212 to a special status, and is the processing of stopping the writing and reading of data which is being used by the application program 211, and shifting the status of such data from an unstable status such as during file open to a status where it can be used with certainty. This is realized by using the operating interface provided by the OS 212 or the application program 211.

Subsequently, the management computer 100 acquires protected data by replicating the data being used by the host computer 200 based on the copy function of the storage system 300 (step 4120). Specifically, the management computer 100 creates the IO request 7300 by using the copy information table 113 indicated by the current copy information table 1159 of the protected data management table 115. With the IO request 7300, the command description is configured as the local copy temporary synchronization. Subsequently, the management computer 100 commands the cancellation of quiescence of the application 211 of the host computer 200 (step 4130). The same interface as quiescence is used for the cancellation of quiescence.

Subsequently, the management computer 100 registers information concerning the protected data acquired in the series of processes of steps 4110, 4120, 4130 in the catalog management table 116 (step 4140). In other words, the current time is registered in the protection time 1161, the current copy information table 1159 of the protected data management table 115 is registered in the copy ID 1162, and the number 1158 corresponding to the implementation of the foregoing processing in the protected data management table 115 is registered in the protected data management table number 1163. Subsequently, the management computer 100 configures the name of the copy information table 113 that is scheduled to subsequently use the current copy information table 1159 of the protected data management table 115. The name of the copy information table 113 includes, as described above, the total number of generations and the generation number indicated by the copy information table 113, and the management computer 100 uses such name information. Subsequently, the management computer 100 registers the processes of steps 4110, 4120, 4130 in its own scheduler so that they will be started at the scheduled implementation time, and thereby ends the processing.

### (3) Replicated Data Use Stage

The management operation of the data use stage by the management computer 100 in this embodiment is now explained. The data use stage is the stage of using the protected data that was acquired in the data replication stage.

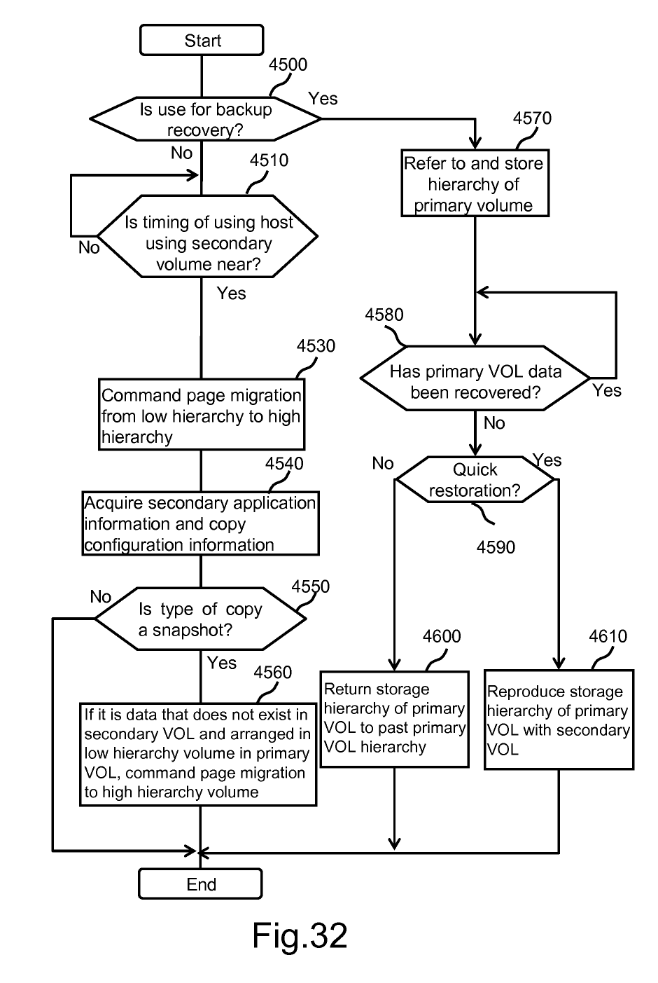

FIG. 32 is an example of the flowchart of the management operation in the data use stage performed by the management computer 100 in the first embodiment.

Foremost, the management computer 100 confirms the catalog information table 116, and confirms that the protected data has been acquired in the storage system 300. If the protected data has been acquired, the management computer 100 refers to the protected data management table number 1163 of the catalog information table 116, and identifies the entry (row information from the number 1150 to the current copy information table 1159) of the corresponding protected data management table 115. Subsequently, the management computer 100 refers to the purpose 1155 of the identified entry (specific entry), and identifies whether the purpose of the protected data is backup recovery or secondary use (step 4500). If the purpose is secondary use (No in step 4500), the management computer 100 refers to the period of use 1157 of this specific entry, and determines whether secondary use will be started in a short period of time (step 4510). If the secondary use will not be started in a short period of time (No in step 4510), the management computer 100 reserves the processing until it approaches the start time.

If the secondary use will be started in a short period of time (Yes in step 4510), the management computer 100 refers to the copy information table 113 indicated by the copy ID 1162 of the catalog information table 116, and identifies the secondary volume storing the protected data by referring to the secondary volume ID 1136. Subsequently, the management computer 100 issues an IO request 7300 to the storage system 300 with the command description 73002 as high-order hierarchy migration so as to migrate data of the identified secondary volume to a real volume of high hierarchy (step 4530).

When the I/O control unit 1300 of the storage system 300 receives this IO request 7300, it refers to the virtual logical volume management information 1270 storing the information of the secondary volume indicated by the IO request 7300, sets the access frequency of the assignment information of the assigned pages in the secondary volume of the storage hierarchy pool management information 1290 to a maximum value, and thereby starts the hierarchy control processing.

In addition, the management computer 100 refers to the copy information 1131 of the copy information table 113 and determines whether the copy is a snapshot (step 4550). If the copy is a snapshot (Yes in step 4550), the management computer 100 issues an IO request 7300 (command description 73002 acquires the status) to the storage system 300, and acquires the address of the logical volume of the data retained in the secondary volume. Subsequently, the management computer 100 compares the address information of the protected data 1156 stored in the protected data management table 115, and identifies data among the protected data which does not exist in the secondary volume. Thus, the management computer 100 issues an IO request 7300 to the storage system 300 with the command description 73002 as high-order hierarchy migration so as to migrate the data among the protected data which does not exist in the secondary volume to a higher hierarchy of the primary volume (step 4560).

Upon using a snapshot, since it is necessary to access the primary volume even if the access is to the secondary volume, the primary volume will also be subject to a load. Nevertheless, as described above, as a result of issuing a command for actively migrating data of the primary volume that is not stored in the secondary volume to a high-order hierarchy, such data can be consequently migrated to the high-order hierarchy, and the load of the primary volume can thereby be inhibited.

Meanwhile, if the purpose of protected data is backup recovery (Yes in step 4500), the management computer 100 issues an IO request 7300 to the storage system 300, and acquires information concerning the hierarchy arrangement of the primary volume from the storage system 300. The storage system 300 returns the hierarchy number stored in the hierarchy address pointer 12705 of the virtual logical volume management information 1270 of the primary volume, together with the virtual address 12704, to the management computer 100. The management computer 100 retains the information that was returned from the storage system 300 in the hierarchy table 117 (step 4570).

Subsequently, the management computer 100 waits for a restoration command (recovery command of the primary volume (primary VOL)) from the user (step 4580).

When the restoration command from the user is issued to the management computer 100, the management computer 100 determines whether that recovery command is quick restoration (step 4590). When the restoration command is quick restoration (Yes in step 4590), the management computer 100 issues an IO request to the storage system 300 by using the information of the hierarchy table 117 as the command for restoring the primary volume in the hierarchy corresponding to the information of the hierarchy table 117 that was retained in step 4570 (step 4610).

When the storage system 300 receives the foregoing IO request 7300, it replaces the address map of the virtual logical volume management information 1270 of the virtual logical volume as the primary volume (volume which was the secondary volume before quick restoration), and implements storage hierarchy control in accordance therewith. The reason why the replacement of the address map is performed to the primary volume is because, at the time up receiving the IO request 7300, the storage system 300 has completed the quick restoration, and it is after the primary volume before restoration and the secondary volume have been switched.

Meanwhile, if the restoration command is restoration that is not quick restoration (No in step 4590), the management computer 100 issues an IO request 7300 to the storage 300 by using the information of the hierarchy table 117 as a command for restoring the primary volume in the hierarchy corresponding to the information of the hierarchy table 117 that was retained in step 4570 (step 4600).

When the storage system 300 receives the foregoing IO request 7300, it replaces the address map of the virtual logical volume management information 1270 of the virtual logical volume as the primary volume (primary volume also before restoration), and implements the storage hierarchy control in accordance therewith.

As described above, according to the first embodiment, the management computer 100 can command the storage system 300 to migrate data to an appropriate hierarchy according to the purpose of the protected data, and the protected data can be used from the host computer 200 in the appropriate performance and reliability according to the usage thereof.

Note that, in step 4530, the hierarchy control processing was performed to all assigned pages in the secondary volume, but the hierarchy control processing may also be performed to certain pages among the assigned page. Even in the foregoing case, performance and reliability more suitable for the usage can be provided in comparison to a case of not performing hierarchy control at all. Moreover, in step 4610, the logical volume was configured to correspond to the information of the hierarchy table 117, but at least a part thereof may be configured to correspond to the information of the hierarchy table 117. Even in the foregoing case, performance and reliability more suitable for the usage can be provided in comparison to a case of not performing hierarchy control at all.

### Embodiment 2

The second embodiment of the present invention is now explained mainly regarding the differences in comparison to the first embodiment (explanation of the common points with the first embodiment is omitted or simplified).

The second embodiment relates to an example of creating a virtual machine in a short period of time by replicating, based on the copy function of the storage system 300, the system image of the host computer 200 (hereinafter referred to as the “virtual server”) comprising a virtualization mechanism (hypervisor) for providing a virtual computer (virtual machine), and using the replicated protected data. The processing of creating the virtual machine as described above is referred to as virtual machine deploy.

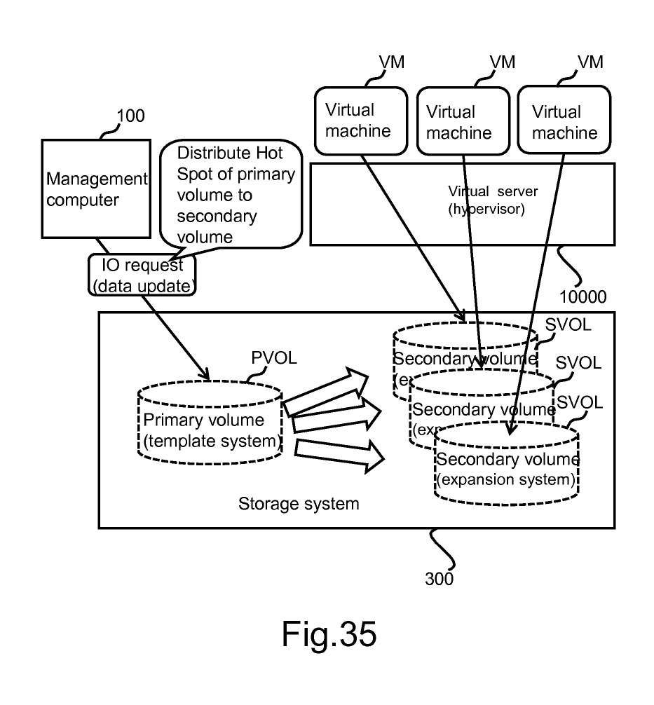

FIG. 35 is a diagram explaining the outline of virtual machine deployment performed by the management computer 100 in the second embodiment.

The virtual machine VM running on the virtual server 10000 is operating by referring to the secondary volume SVOL in the storage system 300. The secondary volume SVOL stores the replication of the system image template of the virtual machine VM stored in the primary volume PVOL. Generally speaking, upon deploying virtual machines VM, it is desirable to deploy as many virtual machines VM as possible during a short period of time. Thus, as the copy of the logical volumes used by the storage system 300, used is the local copy based on a snapshot which does not require the replication of all data.

Here, with the local copy based on a snapshot, data is not actually stored in the secondary volume SVOL if there is no data update in the primary volume PVOL or the secondary volume SVOL. Thus, when the virtual machine VM accesses data; that is, when is performs data access to the secondary volume SVOL, in reality the primary volume PVOL is accessed, and there are cases where the primary volume PVOL becomes overloaded. Here, the area in the primary volume PVOL where the load caused by the data access to the secondary volume SVOL is concentrated is referred to as a hotspot.

Thus, as with the usage of the backup recovery of the first embodiment, it is necessary to perform processing which inhibits hotspots as much as possible in addition to arranging the data of the secondary volume in the real volume of the same hierarchy as the primary volume.

Therefore, the second embodiment discloses a method of distributing the hotspots of the primary volume PVOL in the virtual machine deploy.

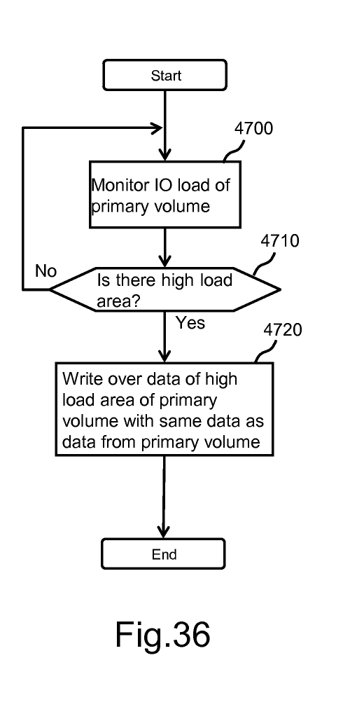

FIG. 36 is an example of the flowchart of the management operation for hotspot load distribution of the virtual machine deploy performed by the management computer 100 in the second embodiment.

Foremost, the management computer 100 confirms that the copy processing running on the storage system 300 is a local copy and a snapshot, and that the copy status is temporary suspension, and subsequently monitors the primary volume SVOL of the copy target. The monitoring is performed to storage system 300 based on the IO request 7300 in order to directly confirm the load information of the primary volume PVOL (step 4700).

Subsequently, the management computer 100 confirms whether the load information of the primary volume PVOL contains a value that is higher than normal (step 4710). Here, if the primary volume PVOL contains a value that is higher than normal (Yes in step 4710), the management computer 100 identifies the area of the high load area of the primary volume PVOL, identifies the data stored in that area by referring to the protected data 1156 of the protected data management table 115, and overwrites that data, according to the same contents, on the primary volume PVOL (step 4720). Based on the foregoing overwriting, the storage system 300 copies that data of the primary volume PVOL to the respective secondary volumes SVOL. Consequently, the subsequent data access to the secondary volume SVOL by the virtual machine VM will be made using the data stored in the secondary volume SVOL, and the IO load of the primary volume PVOL can be reduced. Here, in order to inhibit any inconsistency during the data update to the secondary volume SVOL based on the copy function of the storage system 300, the virtual machine VM may by staticized during the period of the data update to the secondary volume SVOL.

Moreover, in step 4720, a method of overwriting the hotspot of the primary volume PVOL with the data of the same contents was adopted, but, for example, it is also possible for the management computer 100 directly transfer the data of the hotspot to the virtual machine VM, and store the same in the secondary volumes SVOL which are being respectively accessed via the virtual machine VM.

Moreover, in step 4720, for example, the management computer 100 may also create a plurality of replications of the primary volume PVOL in the storage system 300, and cause the plurality of primary volumes PVOL to be accessed in a distributed manner during the access to the hotspot by the virtual machine VM.

As described above, according to the second embodiment, data of the hotspot in the primary volume PVOL of the storage system 300 can be appropriately replicated in the secondary volume SVOL to be accessed by the respective virtual machines VM, and the hotspot of the storage system 300 which arises in the virtual machine deploy of the virtual server 10000 can be effectively inhibited.

Embodiments of the present invention were described above, but this invention is not limited to these embodiments, and it goes without saying that it may be variously modified to the extent that such modification does not deviate from the gist of the invention.

For example, a real volume provided by a storage device (disk drive or the like) of the external storage system 300 may be included in the pool.

### DESCRIPTION OF REFERENCE NUMERALS

100 management computer, 200 host computer, 300 storage system.

1. A computer system, comprising:
a storage system including a pool configured from real storage areas of a plurality of storage media with different characteristics, a plurality of virtual logical volumes configured from virtual storage areas each of which is assigned with a real storage area among the real storage areas configuring the pool, and a controller for controlling the assignment of the real storage areas to the virtual storage areas configuring the virtual logical volumes; and
a management system coupled to the storage system,
wherein the controller:
migrates data managed in the virtual storage area of the virtual logical volume from the assigned real storage area to a real storage area of another storage medium with different characteristics according to predetermined conditions; and
executes copy processing for copying, to a second virtual logical volume, data in a copy target area being at least a part of a virtual storage area of a first virtual logical volume, and
wherein, when the second virtual logical volume is used, the management system controls the controller so as to migrate data of at least apart of the data that has been replicated in the second virtual logical volume by the copy processing, to a real storage area of the storage medium with more favorable characteristics.

2. A computer system according to claim 1,
wherein, when the second virtual logical volume is used by a second application that is different from a first application that has used the copy target area of the first virtual logical volume, the management system controls the controller so as to migrate data of at least apart of the data that has been replicated in the second virtual logical volume by the copy processing, to a real storage area of the storage medium with more favorable characteristics.

3. A computer system according to claim 2,
wherein the management system:
determines whether the copy processing is a snapshot of replicating, in the second virtual logical volume, pre-update data stored in an area to be updated within the copy target area of the first virtual logical volume, and
if the copy processing is the snapshot, controls the controller so as to migrate data of at least a part of an area, within the copy target area of the first virtual logical volume, in which data has not been replicated in the second virtual logical volume, to a real storage area of the storage medium with more favorable characteristics.

4. A computer system according to claim 3,
wherein the management system:
includes a memory for storing time information indicating time at which the second virtual logical volume is used by the second application; and
controls the controller so as to migrate data of at least a part of the second virtual volume to a real storage area of the storage medium with more favorable characteristics based on the time information when the time at which the second virtual logical volume is used approaches.

5. A computer system according to claim 4,
wherein, when the second virtual logical volume is used by the first application that has used the copy target area of the first virtual logical volume, the management system controls the controller so as to migrate data of at least a part of the data replicated in the second virtual volume, to a real storage area of the storage medium with more favorable characteristics.

6. A computer system according to claim 5,
wherein the management system:
stores characteristic information capable of identifying the characteristics of the storage medium including the real storage area that is assigned to the copy target area of the first virtual logical volume when the copy processing is executed; and
controls the controller so as to migrate, based on the characteristic information, data of at least a part of the data replicated in the second virtual logical volume to a real storage area of a storage medium having the same characteristics as the real storage area that has been assigned to replication source data of the copy target area of the first virtual logical volume when the copy processing is executed.

7. A computer system according to claim 6,
wherein the controller restores the copy target area of the first virtual logical volume based on data replicated in the second virtual logical volume, and
the management system controls the controller so as to migrate data of at least a part of the copy target area of the first virtual logical volume to a real storage area of the storage medium with more favorable characteristics.

8. A computer system according to claim 7,
wherein a system image for use by virtual machines is stored in the first virtual logical volume,
the controller executes, as the copy processing, a snapshot of replicating, in a plurality of the second virtual logical volumes, pre-update data stored in an area to be updated within the copy target area of the first virtual logical volume, and
the management system controls the controller to write data of an area with high access frequency within the copy target area of the first virtual logical volume into the same area of the first virtual logical volume, thereby causing data of the area with high access frequency to be written into the plurality of second virtual logical volumes.

9. A computer system according to claim 7,
wherein a system image for use by virtual machines is stored in the first virtual logical volume,
the controller executes, as the copy processing, a snapshot of replicating, in a plurality of the second virtual logical volumes, pre-update data stored in an area to be updated within the copy target area of the first virtual logical volume, and
the management system delivers, to the virtual machines, data of an area with high access frequency within the copy target area of the first virtual logical volume, and causes the virtual machines to write data of the area with high access frequency into the second virtual logical volume.

10. A computer system according to claim 1,
wherein, when the second virtual volume is used by an application that has used the first virtual logical volume, the management system controls the controller so as to migrate data of at least a part of the second virtual logical volume to a real storage area of the storage medium with more favorable characteristics.

11. A computer system according to claim 10,
wherein the management system:
stores characteristics of the real storage area that is assigned to the virtual storage area of the first virtual logical volume when the copy processing is executed; and
controls the controller so as to migrate data of at least apart of the data replicated in the second virtual logical volume, to a real storage area having the same characteristics as the real storage area that has been assigned to the virtual storage area of the first virtual logical volume, which is a copy source of that data, when the copy processing is executed.

12. A computer system according to claim 1,
wherein a system image for use by virtual machines is stored in the first virtual logical volume,
the controller executes, as the copy processing, a snapshot of replicating, in a plurality of the second virtual logical volumes, pre-update data stored in an area to be updated within the copy target area of the first virtual logical volume, and
the management system controls the controller to write data of an area with high access frequency within the copy target area of the first virtual logical volume into the same area of the first virtual logical volume, thereby causing data of the area with high access frequency to be written into the plurality of second virtual logical volumes.

13. A computer system according to claim 1,
wherein a system image for use by virtual machines is stored in the first virtual logical volume,
the controller executes, as the copy processing, a snapshot of replicating, in a plurality of the second virtual logical volumes, pre-update data stored in an area to be updated within the copy target area of the first virtual logical volume, and
the management system delivers, to the virtual machines, data of an area with high access frequency within the copy target area of the first virtual logical volume, and causes the virtual machines to write data of the area with high access frequency into the second virtual logical volume.

14. A management system coupled to a storage system including a pool configured from real storage areas of a plurality of storage media with different characteristics, a plurality of virtual logical volumes configured from virtual storage areas each of which is assigned with a real storage area among the real storage areas configuring the pool, and a controller for controlling the assignment of the real storage areas to the virtual storage areas configuring the virtual logical volumes,
wherein the controller:
migrates data managed in the virtual storage area of the virtual logical volume from the assigned real storage area to a real storage area of another storage medium with different characteristics according to predetermined conditions; and
executes copy processing for copying, to a second virtual logical volume, data in a copy target area being at least a part of a virtual storage area of a first virtual logical volume, and
wherein, when the second virtual logical volume is used, the management system controls the controller so as to migrate data of at least apart of the data that has been replicated in the second virtual logical volume by the copy processing, to a real storage area of the storage medium with more favorable characteristics.

15. A data management method for managing data in a computer system having:
a storage system including a pool configured from real storage areas of a plurality of storage media with different characteristics, a plurality of virtual logical volumes configured from virtual storage areas each of which is assigned with a real storage area among the real storage areas configuring the pool, and a controller for controlling the assignment of the real storage areas to the virtual storage areas configuring the virtual logical volumes; and
a management system coupled to the storage system,
wherein, in the storage system:
data managed in the virtual storage area of the virtual logical volume is migrated from the assigned real storage area to a real storage area of another storage medium with different characteristics according to predetermined conditions; and
copy processing is executed for copying, to a second virtual logical volume, data in a copy target area being at least a part of a virtual storage area of a first virtual logical volume, and
wherein, in the computer system, when the second virtual logical volume is used, the storage system is controlled so as to migrate data of at least apart of the data that has been replicated in the second virtual logical volume by the copy processing to a real storage area of the storage medium with more favorable characteristics.
